(19) United States
(12) Patent Application Publication
(10) Pub. No.: US 2012/0254611 A1
(43) Pub. Date: Oct. 4, 2012

(54) COMMUNICATION APPARATUS, COMMUNICATION SYSTEM, AND COMMUNICATION METHOD

(75) Inventors: Isamu FUKUDA, Kawasaki (JP); Katsuhiko NEGOTO, Kawasaki (JP)

(73) Assignee: FUJITSU LIMITED, Kawasaki-shi (JP)

(21) Appl. No.: 13/361,356

(22) Filed: Jan. 30, 2012

(30) Foreign Application Priority Data
Apr. 4, 2011 (JP) 2011-083144

(51) Int. Cl. H04L 9/00

(52) U.S. Cl. 713/160

(57) ABSTRACT

A communication apparatus includes a processor configured to determine whether a secure path has been established between the communication apparatus and a first communication apparatus, when communication apparatus transmits to the first communication apparatus, a command that causes execution of a given operation; an acquirer that acquires a transmission-side key having a given correspondence relation with a reception-side key that is acquired by the first communication apparatus; and a transmitter that transmits to the first communication apparatus a packet that includes the acquired transmission-side key and the command, if the processor has determined that the secure path has not been established.

### CROSS REFERENCE TO RELATED APPLICATIONS

This application is based upon and claims the benefit of priority of the prior Japanese Patent Application No. 2011-083144, filed on Apr. 4, 2011, the entire contents of which are incorporated herein by reference.

### FIELD

The embodiments discussed herein are related to a communication apparatus, communication system, and communication method.

### BACKGROUND

Mobile communication systems have become infrastructure supporting a social foundation. Thus, assured security and rapid restoration of services when trouble occurs are demanded of mobile communication systems. For example, an evolution node B (eNB), which is a base station that performs wireless communication with mobile stations, is provided on building rooftops, in tunnels, on mountaintops, etc. and is connected to using a general network.

Thus, communication that assures a secure path, such as that offered by the Security Architecture for Internet Protocol (IPsec) is demanded for communication with the eNB. Further, when trouble occurs at the eNB, an operator has to go to the installation site and perform operations to restore services, for example. In this case, the time consumed from the occurrence of the trouble until restoration affects service.

Meanwhile, a means of eliminating the cause of trouble by remote operation, such as restarting by an urgent packet transmitted from an external source, so that the mobile communication system continually provides stable service is further demanded (refer to, for example, Japanese Laid-Open Patent Publication Nos. 2009-130746 and H11-274996).

Nonetheless, with the conventional technologies above, if a secure path is not established with the communication apparatus that is subject to restoration, remote operation by an urgent packet cannot be performed while security is being established. For example, if the communication of an urgent packet is permitted when no secure path has been established, a malicious third party can conceivably transmit an urgent packet and perform fraudulent, remote operation of the communication apparatus.

### SUMMARY

According to an aspect of an embodiment, a communication apparatus includes a processor configured to determine whether a secure path has been established between the communication apparatus and a first communication apparatus, when communication apparatus transmits to the first communication apparatus, a command that causes execution of a given operation; an acquirer that acquires a transmission-side key having a given correspondence relation with a reception-side key that is acquired by the first communication apparatus; and a transmitter that transmits to the first communication apparatus a packet that includes the acquired transmission-side key and the command, if the processor has determined that the secure path has not been established.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a configuration of a communication system according to an embodiment.

FIG. 2 depicts an application example of the communication system depicted in FIG. 1.

FIG. 3 is a sequence diagram of a first operation example of the communication system depicted in FIG. 2.

FIG. 4A is a diagram of one example of a hardware configuration of an eNB.

FIG. 4B is a diagram of one example of a hardware configuration of an OPE.

FIG. 4C is a diagram of one example of a hardware configuration of an MME.

FIG. 5A is a diagram of one example of a functional configuration of the eNB.

FIG. 5B is a diagram of one example of a functional configuration of the OPE.

FIG. 5C is a diagram of one example of a functional configuration of the MME.

FIG. 6 is a diagram of one example of an urgent packet when a secure path is established.

FIG. 7 is a diagram of one example of an urgent packet when a secure path is not established.

FIG. 8 is a diagram of one example of an urgent key exchange packet.

FIG. 9 is a diagram of another example of an urgent key exchange packet.

FIG. 10 is a diagram of one example of key management information.

FIGS. 11A and 11B are sequence diagrams of a second operation example of the communication system depicted in FIG. 2.

FIG. 12 is a flowchart of one example of a key management process.

FIG. 13A and FIG. 13B are flowcharts of an example of a process when an urgent packet is received.

FIG. 14 is a flowchart of one example of a process when an urgent packet is transmitted.

### DESCRIPTION OF EMBODIMENTS

Preferred embodiments of the present invention will be explained with reference to the accompanying drawings.

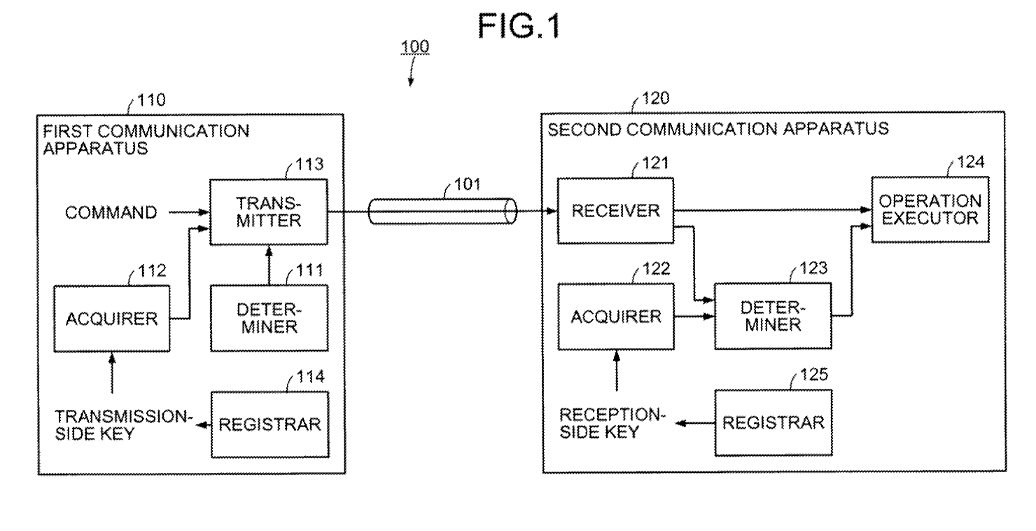

FIG. 1 is a diagram of a configuration of a communication system according to an embodiment. As depicted in FIG. 1, a communication system 100 according to the embodiment includes a communication apparatus 110 (first communication apparatus) and a communication apparatus 120 (second communication apparatus). The communication apparatus 120 is subject to remote operation by the communication apparatus 110. A base station that performs wireless communication with mobile stations may be applied as the communication apparatus 120. An LTE-compliant eNB, etc. may be given as an example of a base station.

LTE-compliant operation equipment (OPE), mobility management entity (MME), etc., for example, may be applied as the communication apparatus 110.

A secure path 101 is established between the communication apparatus 110 and the communication apparatus 120. The secure path 101, for example, is a path for which security has been established and along which encrypted packets are transmitted. For example, the secure path 101 is security association (SA) established by IPsec.

The secure path 101 may be lost consequent to, for example, trouble at the communication apparatus 120. Further, the secure path 101 does not have to be established between the communication apparatus 110 and the communication apparatus 120. For example, a secure gateway (GW) may be provided between the communication apparatus 110 and the communication apparatus 120, where the secure path 101 is established between the secure GW and the communication apparatus 120.

When the secure path 101 is established between the secure GW and the communication apparatus 120, the communication apparatus 110 communicates with the communication apparatus 120 using the secure path 101, by way of the secure GW. Further, in this case, the path between the communication apparatus 110 and the secure GW is preferably a secure dedicated line.

The communication apparatus 110 remotely operates the communication apparatus 120 by transmitting to the communication apparatus 120, a packet that includes a command causing the execution of a given operation. The packet from the communication apparatus 110 to the communication apparatus 120 is transmitted, for example, when an emergency arises, such as when trouble occurs at the communication apparatus 120. Hereinafter, the packet that the communication apparatus 110 transmits to the communication apparatus 120 is termed as an urgent packet.

A given operation instructed by a command included in an urgent packet is, for example, restarting (rebooting), downloading data from a higher apparatus (for example, the communication apparatus 110), uploading to a higher apparatus, or starting communication by an alternative path. Downloading data from a higher apparatus is the downloading of a program, correction data (patch) for parameters, etc. from a higher apparatus. Uploading to a higher apparatus is, for example, the uploading of information that indicates the state of the communication apparatus 120.

For example, the communication apparatus 110 may include a determiner 111, an acquirer 112, and a transmitter 113. Further, the communication apparatus 110 may include a registrar 114.

When the communication apparatus 110 transmits an urgent packet (command) to the communication apparatus 120, the determiner 111 determines whether the secure path 120 has been established between the communication apparatus 110 and the communication apparatus 120. Determination of whether the secure path 101 has been established can be performed based on, for example, a confirmation of the success or failure of communication with the communication apparatus 120, using the secure path 101, or a notification signal from the secure GW. The determiner 111 notifies the transmitter 113 of the determination result.

The acquirer 112 acquires transmission-side keys. Transmission-side keys are keys that correspond to reception-side keys that are acquired by the communication apparatus 120. In other words, transmission-side keys are keys that can authenticate the communication apparatus 110 at the communication apparatus 120. For example, transmission-side keys are identical to reception-side keys. Further, the transmission-side key is a key that enables confirmation of correspondence to a reception-side key by calculation. For example, the transmission-side key is information for which a hash value calculated by a given algorithm coincides with a reception-side key.

For example, the transmission-side keys are stored to the memory (for example, nonvolatile memory) of the communication apparatus 110 and the acquirer 112 acquires the transmission-side keys from the memory of the communication apparatus 110. Configuration may be such that the memory of the communication apparatus 110 stores therein functions and parameters for calculating the transmission-side keys and the acquirer 112 obtains the transmission-side keys by using the functions and parameters stored in the memory of the communication apparatus 110 to calculate the transmission-side keys. The acquirer 112 outputs the acquired transmission-side keys to the transmitter 113.

The transmitter 113 transmits an urgent packet when, for example, failure occurs at the communication apparatus 120. For example, the communication apparatus 110 includes a detector that detects failure of the communication apparatus 120 and when failure of the communication apparatus 120 is detected by the detector, the transmitter 113 transmits an urgent packet. Alternatively, configuration may be such that the transmitter 113 transmits an urgent packet by, for example, a user operation or a command received from another communication apparatus.

Further, upon receiving notification of a determination result that is from the determiner 111 and indicates that the secure path 101 has not been established, the transmitter 113 transmits to the communication apparatus 120, an urgent packet that includes the transmission-side keys output from the acquirer 112 and a command causing the execution of a given operation. In this case, since the secure path 101 has not been established, the urgent packet is transmitted to the communication apparatus 120 without encryption.

Further, upon receiving notification of a determination that is from the determiner 111 and indicates that the secure path 101 has been established, the transmitter 113 transmits to the communication apparatus 120, an urgent packet that includes a command. In this case, since the secure path 101 has been established, the urgent packet is encrypted and transmitted to the communication apparatus 120.

The registrar 114 registers as the transmission-side keys to be acquired by the acquirer 112, keys having a given correspondence relation with the reception-side keys of the communication apparatus 120. The registration of the transmission-side keys by the registrar 114 is performed by, for example, communication with the communication apparatus 120, using the secure path 101. For example, the registrar 114 stores the transmission-side keys to the memory of the communication apparatus 110. Alternatively, the registrar 114 stores to the memory of the communication apparatus 110, functions and parameters for calculating the transmission-side keys.

For example, the registrar 114 registers the transmission-side keys into the communication apparatus 110 and uses the secure path 101 to transmit to the communication apparatus 120, a signal instructing the registration of reception-side keys having a given correspondence relation with the registered transmission-side keys. Alternatively, the registrar 114 uses the secure path 101 to receive from the communication apparatus 120, a signal instructing the registration of transmission-side keys having a given correspondence relation with reception-side keys registered in the communication apparatus 120. The registrar 114 registers the transmission-side keys, based on the received signal. As a result, the registrar 114 can register, as the transmission-side keys to be acquired by the acquirer 112, keys that have a given correspondence relation with the reception-side keys of the communication apparatus 120

The communication apparatus 120 is subject to remote operation by the communication apparatus 110. The communication apparatus 120 executes a given operation that is based on a command included in an urgent packet transmitted from the communication apparatus 110. For example, the communication apparatus 120 includes a receiver 121, an acquirer 122, a determiner 123, and an operation executor 124. Further, the communication apparatus 120 may include a registrar 125.

The receiver 121 receives from the communication apparatus 110, for example, an urgent packet that includes keys and a command causing the execution of a given operation. Further, configuration may be such that the receiver 121 receives an urgent packet from another communication apparatus that is different from the communication apparatus 110. The receiver 121 outputs to the determiner 123, the keys included in the received urgent packet. Further, the receiver 121 outputs to the operation executor 124, the command included in the received urgent packet.

The acquirer 122 acquires reception-side keys that have a given correspondence relation with the transmission-side keys acquired by the communication apparatus 110. For example, the reception-side keys are stored to the memory (for example, nonvolatile memory) of the communication apparatus 120 and the acquirer 122 acquires the reception-side keys from the memory of the communication apparatus 120. Alternatively, the memory of the communication apparatus 120 stores therein functions and parameters for calculating the reception-side keys and the acquirer 122 obtains the reception-side keys by using the functions and parameters stored in memory of the communication apparatus 120 to calculate the reception-side keys. The acquirer 122 outputs to the determiner 123, the acquired reception-side keys.

The determiner 123 determines whether the keys output from the receiver 121 and the reception-side keys output from the acquirer 122 have a given correspondence relation, enabling determination of whether the urgent packet received by the receiver 121 is that transmitted from the communication apparatus 110. The determiner 123 notifies the operation executor 124 of the determination result.

Upon receiving from the determiner 123, notification of a determination result indicating that the keys output from the receiver 121 and the reception-side keys output from the acquirer 122 have a given correspondence relation, the operation executor 124 executes an operation that is based on the command output from the receiver 121. For example, if a command that causes restarting to be executed is output from the receiver 121, the operation executor 124 causes restarting of the communication apparatus 120.

As a result, if the received urgent packet is that transmitted from the communication apparatus 110, an operation according to a command included in the received urgent packet can be executed. Thus, even if the secure path 101 has not been established, an urgent packet can be safely transmitted and the communication apparatus 120 can be operated by the urgent packet. Consequently, for example, recovery from a failure of the communication apparatus 120 can be performed.

Further, upon receiving notification a determination result that is from the determiner 123 and indicates that the keys output from the receiver 121 and the reception-side keys output from the acquirer 122 do not have a given correspondence relation, the operation executor 124 does execute an operation based on the command output from the receiver 121. As a result, if the received urgent packet is not that transmitted from the communication apparatus 110, configuration can be such that operation based on a command included in the received urgent packet is not executed. Thus, for example, operation of the communication apparatus 120 by an urgent packet (for example, a restart attack from an external source) maliciously transmitted from another communication apparatus different from the communication apparatus 110 can be prevented.

The registrar 125 registers as the reception-side keys to be acquired by the acquirer 122, keys that have a given correspondence relation with the transmission-side keys of the communication apparatus 110. The registration of the reception-side keys by the registrar 125 is performed by, for example, communication with the communication apparatus 110, using the secure path 101. For example, the registrar 125 stores the reception-side keys to the memory of the communication apparatus 120. Alternatively, the registrar 125 stores to the memory of the communication apparatus 120, functions and parameters for calculating the reception-side keys.

For example, the registrar 125 registers the reception-side keys in the communication apparatus 120 and uses the secure path 101 to transmit to the communication apparatus 110, a signal instructing the registration of transmission-side keys that have a given correspondence relation with the registered reception-side keys. Alternatively, the registrar 125 uses the secure path 101 to receive from the communication apparatus 110, a signal instructing the registration of reception-side keys having a given correspondence relation with the transmission-side keys registered at the communication apparatus 110. The registrar 125 registers the reception-side keys, according to the received signal. As a result, the registrar 125 can register as the reception-side keys to be acquired by the acquirer 122, keys that have a given correspondence relation with the transmission-side keys of the communication apparatus 110.

Further, in the registration of keys at the communication apparatus 110 and the communication apparatus 120 that use the secure path 101, for example, a key exchange protocol such as the Internet Key Exchange protocol (IKE) can be used.

Further, configuration may be such that the acquirer 112 of the communication apparatus 110 and the acquirer 122 of the communication apparatus 120 acquire different transmission-side keys and reception-side keys each time an urgent packet is transmitted from the communication apparatus 110 to the communication apparatus 120. For example, the respective memories of the communication apparatus 110 and the communication apparatus 120 store therein multiple classes of transmission-side keys and reception-side keys having a given correspondence relation.

The acquirers 112, 122 acquire from the memory, different transmission-side keys and reception-side keys, each time an urgent packet is received. As a result, for example, even if an urgent packet transmitted from the communication apparatus 110 to the communication apparatus 120 is stolen, the communication apparatus 120 cannot be operated by the stolen urgent packet, enabling improved security.

Further, configuration may be such that the acquirers 112, 122 do not acquire transmission-side keys or reception-side keys for which a given period has elapsed since being registered respectively by the registrars 114, 125. As a result, even if, for example, a transmission-side key or a reception-side key from the communication apparatus 110 or the communication apparatus 120 is stolen, or an urgent packet transmitted from the communication apparatus 110 to the communication apparatus 120 is stolen, the stolen key cannot be used after a given period, enabling improved security.

Further, configuration may be such that the communication apparatus 110 includes an encrypter that encrypts the transmission-side keys acquired by the acquirer 112. The transmitter 113 transmits a packet that includes the transmission-side keys encrypted by the encrypter. In this case, the communication apparatus 120 includes a decrypter that decrypts the encrypted transmission-side keys, which are included in the urgent packet received by the receiver 121. The determiner 123 performs determination based on the transmission-side keys decrypted by the decrypter.

As a result, for example, even if a transmission-side key or a reception-side key from the communication apparatus 110 or the communication apparatus 120 is stolen, the stolen reception-side key cannot be used without an encrypting algorithm or encryption key, enabling security to be improved. In the encryption and the decryption, for example, a common key system such as AES and DES, a public key system such as RSA, or various types of algorithms can be used.

Further, an example where a packet that includes a command instructing the restarting of the communication apparatus 120 is transmitted from the communication apparatus 110 to the communication apparatus 120 will be described. In this case, an interval that begins after the operation executor 124 of the communication apparatus 120 executes the restarting of the communication apparatus 120 (including other operations based on commands from the communication apparatus 110) and lasting until a given period elapses may be regarded as an inhibit interval.

During the inhibit interval, the operation executor 124 does not execute the restarting according to the command from the communication apparatus 110. As a result, for example, even if the communication apparatus 120 is subject to a restart attack in which urgent packets are successively transmitted from a communication apparatus different from the communication apparatus 110, repeated restarting can be prevented. Thus, a situation where the communication apparatus 120 cannot be restored is prevented and security is improved.

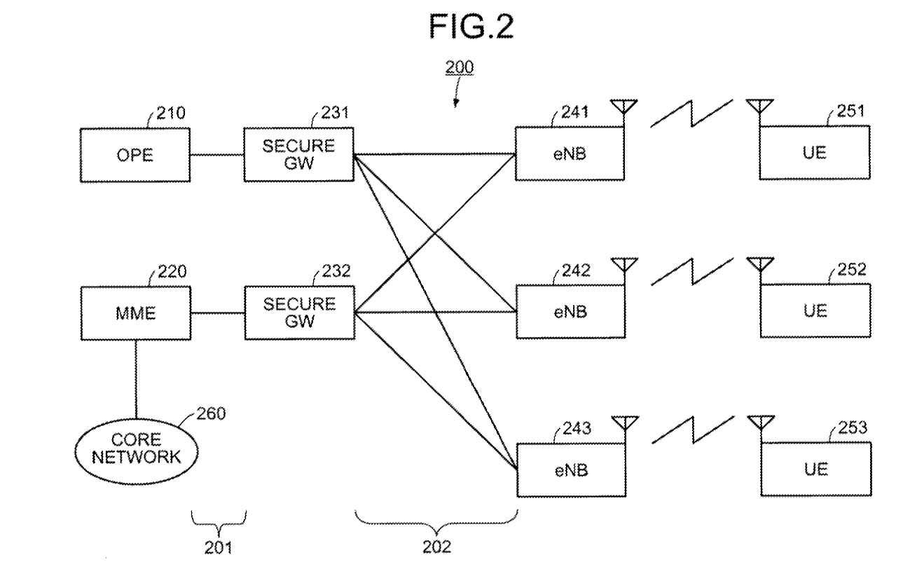

FIG. 2 depicts an application example of the communication system depicted in FIG. 1. A communication system 200 depicted in FIG. 2 is a communication system to which the communication system 100 depicted in FIG. 1 has been applied. The communication system 200 includes OPE 210, MME 220, secure GWs 231 and 232, eNBs 241 to 243, user equipment (UEs) (i.e., user terminal) 251 to 253, and a core network 260.

The communication apparatus 110 depicted in FIG. 1, for example, can be applied to the OPE 210 and the MME 220. Further, the communication apparatus 120 depicted in FIG. 1, for example, can be applied to the eNB 241 to 243. The OPE 210 is connected to the eNBs 241 to 243 via the secure GW 231. The OPE 210 performs maintenance of the eNBs 241 to 243.

The secure GW 231 is a gateway disposed between the OPE 210 and the eNBs 241 to 243. The secure GW 231 establishes a secure path with each of the eNBs 241 to 243. The secure GW 232 is a gateway disposed between the MME 220 and the eNBs 241 to 243. The secure GW 232 establishes a secure path with each of the eNBs 241 to 243.

The MME 220 is connected to the eNBs 241 to 243, via the secure GW 232. Further, the MME 220 is connected to the core network 260. The MME 220 occupies the control C-plane (control signal system) in a network of the eNBs 241 to 243 and the UEs 251 to 253. For example, the MME 220 performs mobility management of the UEs 251 to 253, such as position registration, calling, and handover of the UEs 251 to 253. Further, the MME 220 may maintain the eNBs 241 to 243.

The eNBs 241 to 243 wirelessly communicate with the UEs 251 to 253, respectively, and thereby relay communication between the core network 260 and each of the UEs 251 to 253. The UEs 251 to 253 are mobile stations located in the cells of the eNBs 241 to 243. The UEs 251 to 253 communicate with the core network 260 by the relay performed by the eNBs 241 to 243.

An interval 201 represents an interval between the OPE 210 and the secure GW 231, or an interval between the MME 220 and the secure GW 232. The interval 201 is an unencrypted communication interval in which packets without encryption are transmitted. An interval 202 represents an interval between the secure GWs 231, 232 and the eNBs 241 to 243. The interval 202 is an encrypted communication interval in which encrypted packets are transmitted to establish a secure path.

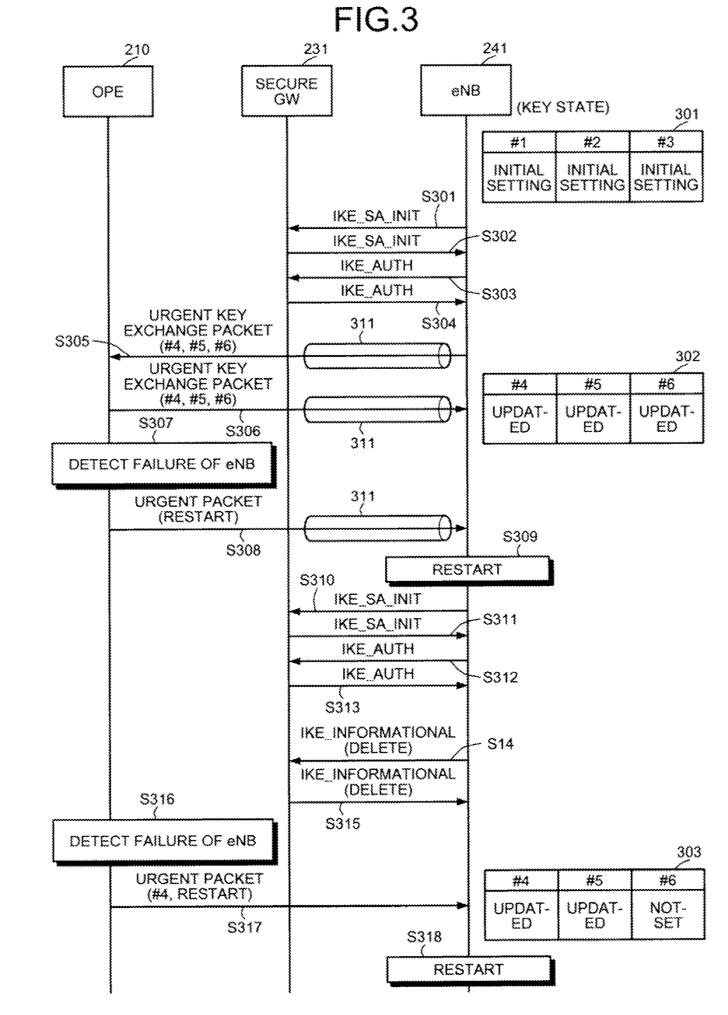

FIG. 3 is a sequence diagram of a first operation example of the communication system depicted in FIG. 2. With reference to FIG. 3, operation of the OPE 210, the secure GW 231, and the eNB 241 when the OPE 210 maintains the eNB 241, will be described. Key states 301 to 303 indicate the states of keys that are set in the OPE 210 and the eNB 241.

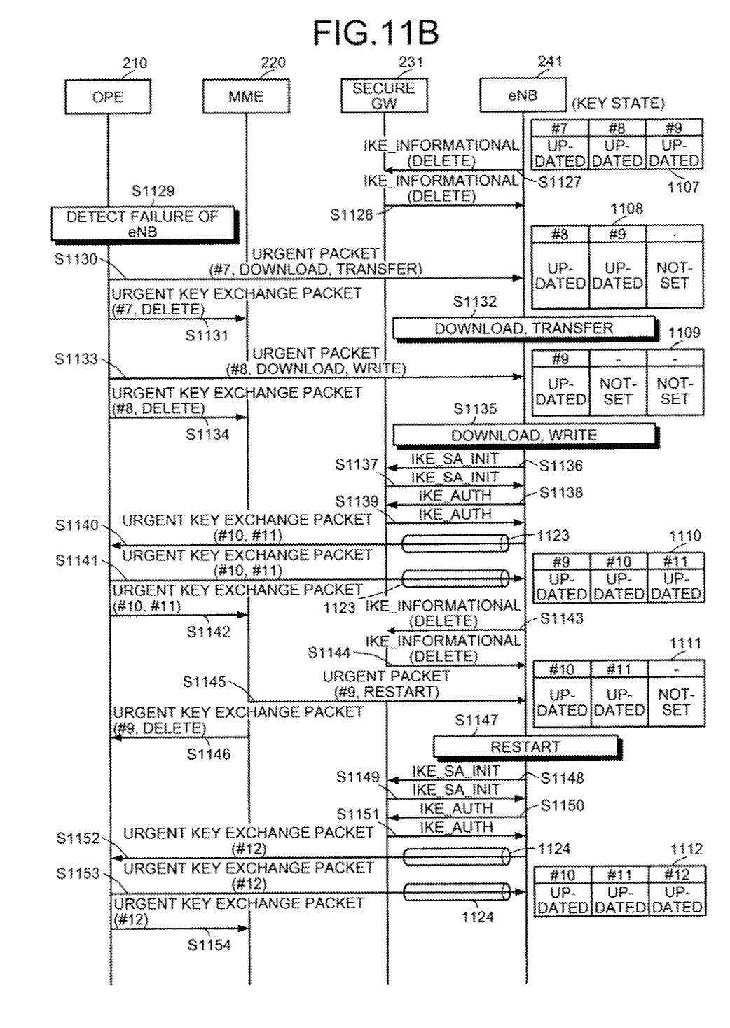

As indicated by the key state 301, for example, keys #1, #2, #3 in the OPE 210 and the eNB 241, are assumed to be set at the factory default settings. The state of the keys #1, #2, #3 (for example, refer to FIG. 10) is “initial setting”. Further, keys are set in 3's in the OPE 210 and the eNB 241.

For example, when power is supplied to the eNB 241 (startup), the eNB 241 transmits to the secure GW 231, a request signal (IKE_SA_INIT) for establishing a secure path (step S301). Next, in response to the request signal transmitted at step S301, the secure GW 231 transmits an acknowledgment signal (IKE_SA INIT) to the eNB 241 (step S302).

The eNB 241 transmits a request signal (IKE_AUTH) to the secure GW 231 (step S303). Next, in response to the request signal transmitted at step S303, the secure GW 231 transmits an acknowledgment signal (IKE_AUTH) to the eNB 241 (step S304). Consequent to steps S301 to S304, a secure path 311 between the eNB 241 and the secure GW 231 is established.

Next, since the key state 301 indicates that the state of each of the keys is “initial setting”, the eNB 241 sets new keys #4, #5, #6 for the eNB 241. Subsequently, the eNB 241 uses the secure path 311 established by steps S301 to S304 and transmits to the OPE 210, an urgent key exchange packet instructing the addition of the keys #4, #5, #6 (step S305).

The OPE 210 sets therein, the keys #4, #5, #6 according to the urgent key exchange packet transmitted at step S305. Subsequently, the OPE 210 uses the secure path 311 and transmits to the eNB 241, an urgent key exchange packet indicating that the keys #4, #5, #6 have been set (step S306).

As indicated by the key state 302, consequent to steps S305 to S306, the keys set in the OPE 210 and the eNB 241 are updated to the keys #4, #5, #6. Further, the state of each of the keys #4, #5, #6 becomes “updated”.

Here, it is assumed that failure occurs at the eNB 241 during a state when the secure path 311 is established. In this case, the OPE 210 detects the failure of the eNB 241 (step S307). Detection of the failure of the eNB 241 can be performed based on, for example, confirmation of communication with the eNB 241 or a notification signal from the eNB 241.

Next, the OPE 210 transmits to the eNB 241, an urgent packet that includes a command instructing restarting (step S308). At step S308, since the secure path 311 is established, the OPE 210 may omit appending the keys to the urgent packet. Next, the eNB 241 performs restarting, according to the urgent packet transmitted at step S308 (step S309).

Since the eNB 241 was restarted at step S309, the eNB 241 transmits to the secure GW 231, a request signal (IKE_SA_INIT) for establishing a secure path (step S310). Next, in response to the request signal transmitted at step S310, the secure GW 231 transmits an acknowledgment signal (IKE_SA_INIT) to the eNB 241 (step S311).

The eNB 241 transmits a request signal (IKE_AUTH) to the secure GW 231 (step S312). Next, in response to the request signal transmitted at step S312, the secure GW 231 transmits an acknowledgment signal (IKE_AUTH) to the eNB 241 (step S313). Consequent to steps S310 to S313, a new IKE secure path 312 is established between the eNB 241 and the secure GW 231.

Here, it is assumed that an abnormality occurs on the secure path 311 established by steps S310 to S313. In this case, upon detecting the abnormality on the secure path 311, the eNB 241 transmits an IKE packet to the secure GW 231 (step S314). Subsequently, the secure GW 231 transmits an IKE packet to the eNB 241 (step S315). The IKE packets transmitted at steps S314, S315 are, for example, IKE_INFORMATIONAL(DELETE). As a result, the secure path 312 is dropped.

Here, it is assumed that failure occurs at the eNB 241 during a state when the secure path 312 has been dropped. In this case, the OPE 210 detects the failure of the eNB 241 (step S316). Detection of the failure of the eNB 241 can be performed based on, for example, confirmation of communication with the eNB 241 or a notification signal from the eNB 241.

Next, the OPE 210 transmits to the eNB 241, an urgent packet that includes a command instructing restarting (step S317). Since the secure path 312 has been dropped, at step S317, the OPE 210 appends to the urgent packet, the key #4, which has the smallest key number among the keys #4, #5, #6 set in the OPE 210. Further, configuration may be such that the OPE 210 encrypts the key #4 by a given scheme, and appends the encrypted key #4 to the urgent packet. The OPE 210 further deletes from among the keys set in the OPE 210, the key #4, which was appended to the urgent packet.

Next, since the key #4 included in the urgent packet transmitted at step S317 coincides with the key #4 set in the eNB 241, the eNB 241 performs restarting, according to the urgent packet (step S318). Further, since the eNB 241 received an urgent packet that included the key #4, the eNB 241 deletes the key #4 from among the keys set therein.

Consequently, as indicated by the key state 303, among the keys in the OPE 210 and the eNB 241, two are set as the keys #5, #6. Further, the state of one of the keys in the OPE 210 and the eNB 241 is “not set”. As depicted in FIG. 3, the OPE 210 and the eNB 241 use IKE and communicate urgent key exchange packets, thereby enabling keys to be exchanged. In this manner, by using a general key exchange protocol, functions for key exchange at each apparatus can be implemented easily.

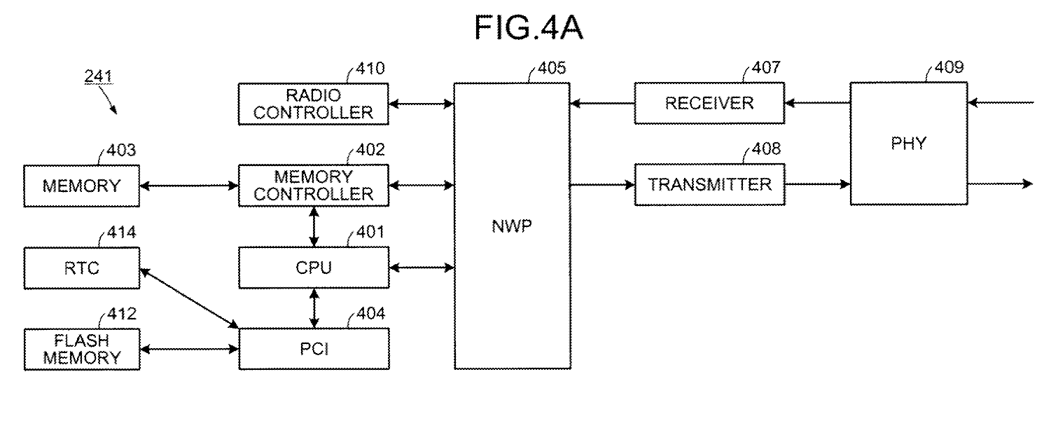

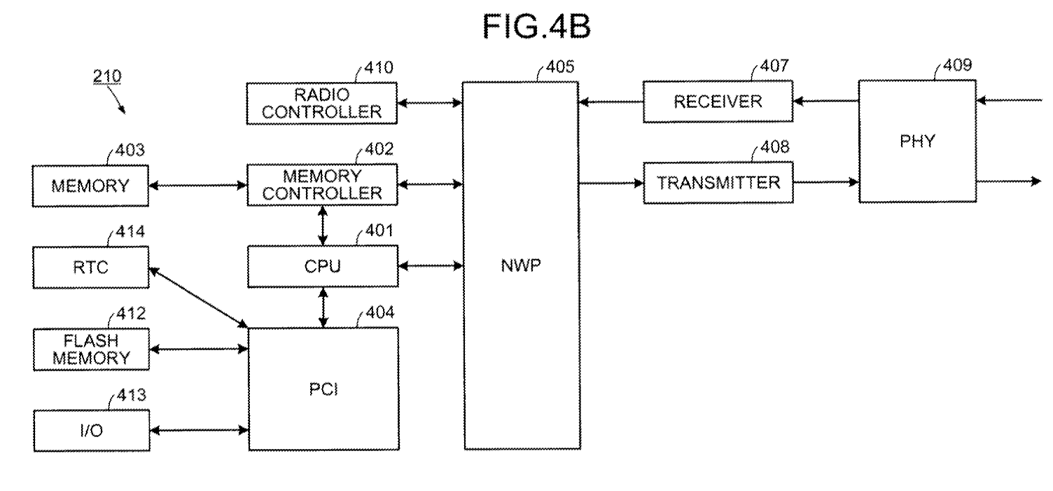

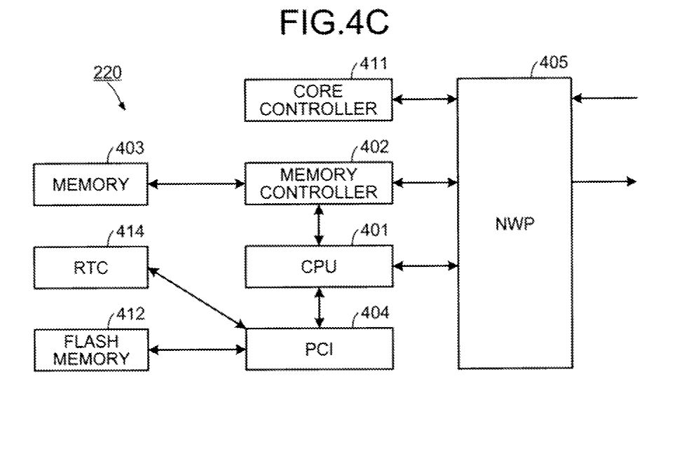

FIG. 4A is a diagram of one example of the hardware configuration of the eNB. Although description will be given with respect to the eNB 241, the same configuration is applicable to the eNBs 242, 243. As depicted in FIG. 4A, the eNB 241 includes, for example, a central processing unit (CPU) 401, a memory controller 402, a memory 403, a PCI 404, a network processor (NWP) 405, a receiver interface 407, a transmitter interface 408, a physical interface 409, a radio controller 410, a flash memory 412, and a real-time clock 414.

The CPU 401 is a host processor that governs overall control of the eNB 241. The memory controller 402 controls the reading and writing of data from and to the memory 403, under the control of the CPU 401.

The memory 403 is local memory. The PCI 404 is an external interface connected to the real-time clock 414, the flash memory 412, etc. The PCI 404 is controlled, for example, by the CPU 401. Further, the PCI 404 may be controlled by the NWP 405, through the CPU 401.

The NWP 405 is a network processor that controls the communication of the eNB 241, based on control from the CPU 401. The NWP 405 performs IPSec termination processing, IKE processing, protocol termination processing, key generation processing, encryption and decryption processing, etc. The NWP 405 may be implemented by, for example, a program executed by the CPU 401, as software.

The receiver interface 407 (receiver) is an interface that performs data reception via the physical interface 409, based on control from the NWP 405. The transmitter interface 408 (transmitter) is an interface that performs data transmission via the physical interface 409, based on control from the NWP 405. The physical interface 409 (PHY) is a communication interface connected to a network. For example, the physical interface 409 includes a physical interface that performs wired communication with the secure GW 231, 232 and a physical interface that performs wireless communication with the UE 251.

The radio controller 410 controls wireless communication, based on control from the NWP 405. For example, the radio controller 410 controls the receiver interface 407, the transmitter interface 408, and the physical interface 409 via the NWP 405, to thereby control the wireless communication between the eNB 241 and the UE 251.

The flash memory 412 is nonvolatile memory connected to the PCI 404. The real-time clock 414 (RTC) is a clock circuit that outputs the current time and is connected to the PCI 404.

The receiver 121 depicted in FIG. 1 can be implemented by, for example, the NWP 405, the transmitter interface 408, and the physical interface 409. The acquirer 122 depicted in FIG. 1 can be implemented by, for example, the memory controller 402 and the memory 403. The determiner 123 depicted in FIG. 1 can be implemented by, for example, the CPU 401 and the NWP 405. The operation executor 124 depicted in FIG. 1 can be implemented by, for example, the CPU 401. The registrar 125 depicted in FIG. 1 can be implemented by, for example, the memory controller 402 and the NWP 405.

FIG. 4B is a diagram of one example of the hardware configuration of the OPE. In FIG. 4B, components identical to those depicted in FIG. 4A are given the same reference numerals used in FIG. 4A and description thereof is omitted. As depicted in FIG. 4B, the OPE 210 includes, for example, the CPU 401, the memory controller 402, the memory 403, the PCI 404, the NWP 405, the receiver interface 407, the transmitter interface 408, the physical interface 409, the radio controller 410, the flash memory 412, a user interface 413, and the real-time clock 414.

The physical interface 409 of the OPE 210, for example, includes a physical interface that performs wired communication with the eNBs 241 to 243, via the secure GW 231. The user interface 413 (input/output (I/O)) is an interface between the eNB 241 and the user, and is connected to the PCI 404. The user interface 413, for example, is a display, a keyboard, etc. The user interface 413 of the OPE 210, for example, receives a user operation that instructs the OPE 210 to transmit an urgent packet. Further, the user interface 413 may notify the user of transmission results concerning the urgent packet transmitted by the OPE 210.

The determiner 111 depicted in FIG. 1 can be implemented by, for example, the NWP 405. The acquirer 112 depicted in FIG. 1 can be implemented by, for example, the memory controller 402 and the memory 403. The transmitter 113 depicted in FIG. 1 can be implemented by, for example, the NWP 405, the transmitter interface 408, and the physical interface 409. The registrar 114 depicted in FIG. 1 can be implemented by, for example, the memory controller 402, the memory 403, and the NWP 405.

FIG. 4C is a diagram of one example of the hardware configuration of the MME. In FIG. 4C, components identical to those depicted in FIG. 4A or FIG. 4B are given same reference numerals used in FIG. 4A and FIG. 4B, and description thereof is omitted. As depicted in FIG. 4C, the MME 220 includes, for example, the CPU 401, the memory controller 402, the memory 403, the PCI 404, the NWP 405, a core network controller 411, the flash memory 412, and the real-time clock 414. The core network controller 411 (core controller) of the MME 220 controls communication with the core network 260, based on control from the NWP 405.

The determiner 111 depicted in FIG. 1 can be implemented by, for example, the NWP 405. The acquirer 112 depicted in FIG. 1 can be implemented by, for example, the memory controller 402 and the memory 403. The transmitter 113 depicted in FIG. 1 can be implemented by, for example, the NWP 405, the transmitter interface 408, and the physical interface 409. The registrar 114 depicted in FIG. 1 can be implemented by, for example, the memory controller 402, the memory 403, and the NWP 405.

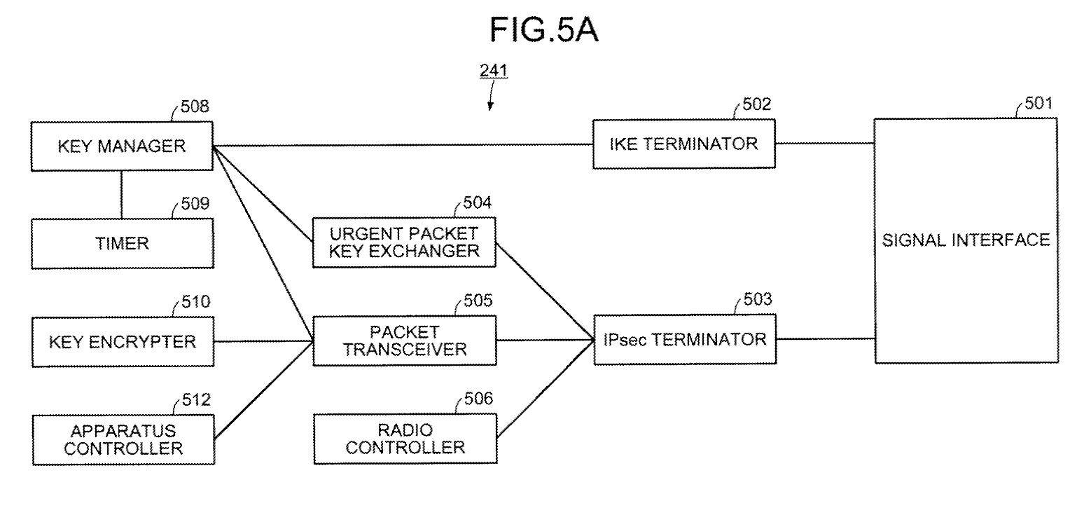

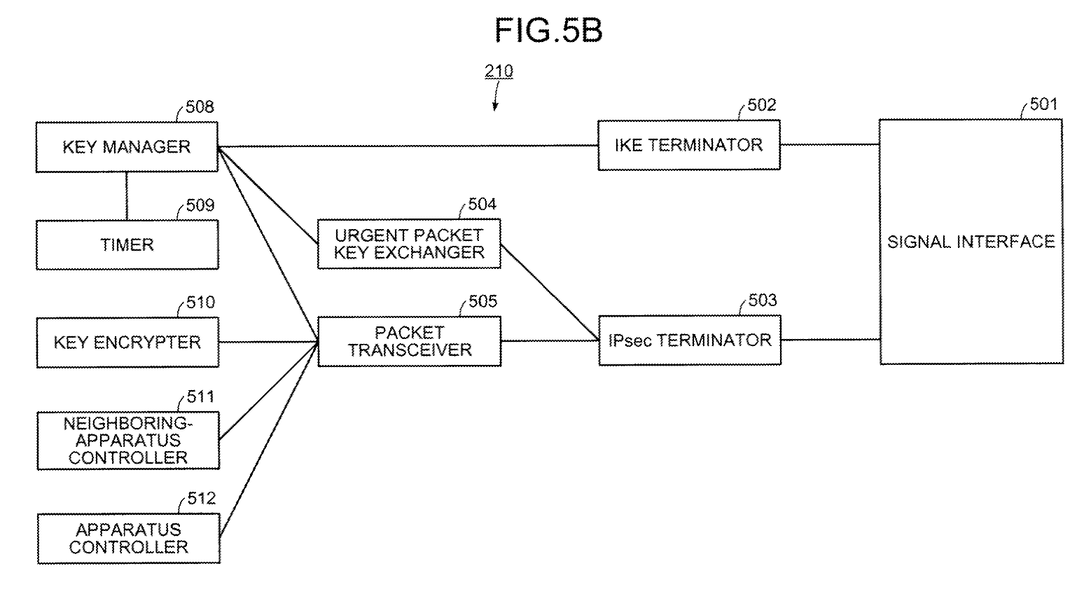

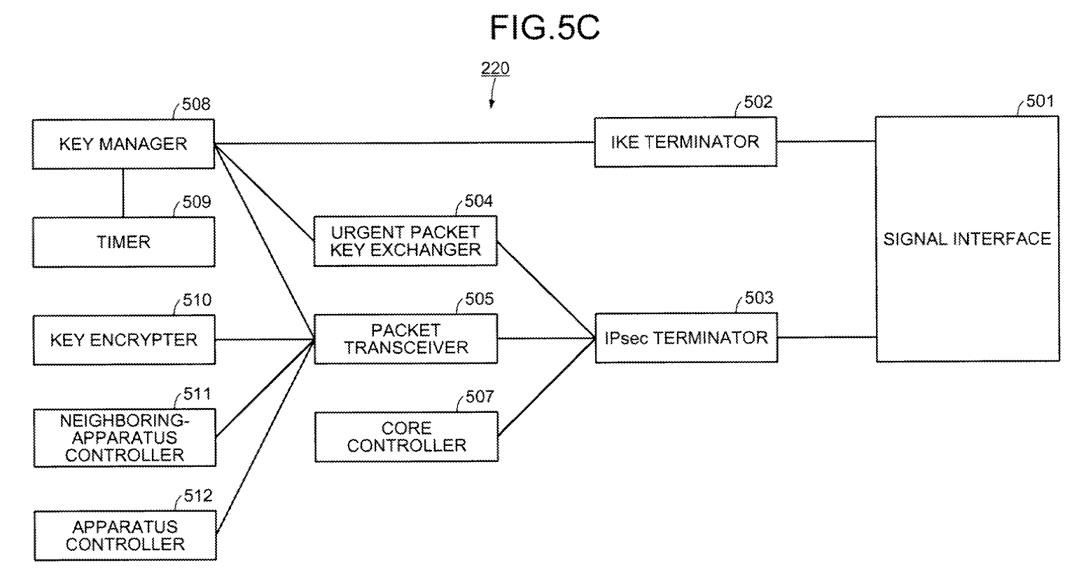

FIG. 5A is a diagram of one example of the functional configuration of the eNB. Although description will be given with respect to the eNB 241, the same configuration is applicable to the eNBs 242, 243. As depicted in FIG. 5A, the eNB 241 includes, for example, a signal interface 501, an IKE terminator 502, an IPsec terminator 503, an urgent packet key exchanger 504, a packet transceiver 505, a radio controller 506, a key manager 508, a timer 509, a key encrypter 510, and an apparatus controller 512.

The signal interface 501 performs packet communication between apparatuses. For example, during transmission, the signal interface 501 transmits packets to an external apparatus. Further, during reception, the signal interface 501 performs protocol analysis for the received packet, and notifies the corresponding terminal function unit. The signal interface 501 of the eNB 241, for example, communicates with the secure GW 231. The signal interface 501 can be implemented by, for example, the receiver interface 407, the transmitter interface 408, and the physical interface 409 depicted in FIG. 4A.

The IKE terminator 502 terminates IKE packets. For example, the IKE terminator 502 communicates, via the signal interface 501, IKE packets such as IKE_SA and CHILD_SA related to IPsec. Further, the IKE terminator 502 generates, updates, and deletes SAs that include keys. The IKE terminator 502 outputs to the key manager 508, results of key exchange by IKE. The IKE terminator 502 can be implemented by, for example, the NWP 405 depicted in FIG. 4A.

The IPsec terminator 503 terminates IPsec packets. For example, the IPsec terminator 503 encrypts plain text packets and transmits the encrypted plain text packets to an external apparatus, via the signal interface 501. Further, the IPsec terminator 503 decrypts encrypted packets received via the signal interface 501 and outputs the decrypted packets to the functional units. The IPsec terminator 503 outputs a plain text urgent packet to the urgent packet key exchanger 504, when IPsec is not established. The IPsec terminator 503 can be implemented by, for example, the NWP 405 depicted in FIG. 4A.

The urgent packet key exchanger 504 terminates key exchange packets for urgent packets, via the signal interface 501 and the IPsec terminator 503. For example, the signal interface 501 transmits urgent key exchange packets to an external apparatus. Further, the signal interface 501 receives urgent key exchange packets and outputs the received urgent key exchange packets to the key manager 508. The urgent packet key exchanger 504 can be implemented by, for example, the NWP 405 depicted in FIG. 4A.

The packet transceiver 505 communicates urgent packets, via the signal interface 501 and the IPsec terminator 503. The packet transceiver 505 of the eNB 241 receives urgent packets and outputs to the apparatus controller 512, commands included in the received urgent packets. The packet transceiver 505 can be implemented by, for example, the NWP 405 depicted in FIG. 4A.

The radio controller 506 controls wireless communication with the UE 251. For example, the radio controller 506 performs wireless resource management, handover of the UE 251 between base stations, wireless protocol exchange, etc. The radio controller 506 can be implemented by, for example, the radio controller 410 depicted in FIG. 4A.

The key manager 508 manages key management information (for example, refer to FIG. 10) that includes keys and information related to the keys, and thereby generates, updates, and deletes keys for urgent packets. For example, the key manager 508 generates key data that is used in key negotiations and outputs the generated key data to the urgent packet key exchanger 504 (or the IKE terminator 502). Further, the key manager 508 generates keys, based on received key data and stores the generated keys to nonvolatile memory. The key manager 508 can be implemented by, for example, the NWP 405 and the flash memory 412 depicted in FIG. 4A.

The timer 509 gives notification of the time information. For example, the timer 509 gives notification of whether the current time has passed a time specified by the key manager 508. The timer 509 can be implemented by, for example, the real-time clock 414 depicted in FIG. 4A. The key encrypter 510 of the eNB 241 decrypts keys of urgent packets. The key encrypter 510 can be implemented by, for example, the NWP 405 depicted in FIG. 4A.

The apparatus controller 512 controls the eNB 241. For example, based on commands output from the packet transceiver 505, the apparatus controller 512 performs restoration operations such as restarting, downloading, uploading, etc. The apparatus controller 512 can be implemented by, for example, the CPU 401 depicted in FIG. 4A.

FIG. 5B is a diagram of one example of the functional configuration of the OPE. In FIG. 5B, components identical to those depicted in FIG. 5A are given the same reference numerals used in FIG. 5A and description thereof is omitted. As depicted in FIG. 5B, the OPE 210 includes, for example, the signal interface 501, the IKE terminator 502, the IPsec terminator 503, the urgent packet key exchanger 504, the packet transceiver 505, the key manager 508, the timer 509, the key encrypter 510, a neighboring-apparatus controller 511, and the apparatus controller 512.

The signal interface 501 of the OPE 210, for example, communicates with the secure GW 231. The packet transceiver 505 of the OPE 210, for example, under the control of the neighboring-apparatus controller, transmits urgent packets via the IPsec terminator 503 and the signal interface 501.

The key encrypter 510 of the OPE 210 encrypts the keys of the urgent packets transmitted by the packet transceiver 505. The neighboring-apparatus controller, for example, controls the neighboring apparatus eNB 241, etc. For example, the neighboring-apparatus controller detects failure of the eNB 241. Further, the neighboring-apparatus controller, for example, transmits an urgent packet to the eNB 241 via the packet transceiver 505, thereby causing restarting of the eNB 241. The neighboring-apparatus controller can be implemented by, for example, the radio controller 410 depicted in FIG. 4B.

The signal interface 501 can be implemented by, for example, the receiver interface 407, the transmitter interface 408, and the physical interface 409, depicted in FIG. 4B. The IKE terminator 502 can be implemented by, for example, the NWP 405 depicted in FIG. 4B. The IPsec terminator 503 can be implemented by, for example, the NWP 405 depicted in FIG. 4B.

The urgent packet key exchanger 504 can be implemented by, for example, the NWP 405 depicted in FIG. 4B. The packet transceiver 505 can be implemented by, for example, the NWP 405 depicted in FIG. 4B. The key manager 508 can be implemented by, for example, the NWP 405 and the flash memory 412 depicted in FIG. 4B.

The timer 509 can be implemented by, for example, the real-time clock 414 depicted in FIG. 4B. The key encrypter 510 can be implemented by, for example, the NWP 405 depicted in FIG. 4B. The apparatus controller 512 can be implemented by, for example, the CPU 401 depicted in FIG. 4B.

FIG. 5C is a diagram of one example of the functional configuration of the MME. In FIG. 5C, components identical to those depicted in FIG. 5A or FIG. 5B are given the same reference numerals used in FIG. 5A and FIG. 5B, and description thereof is omitted. As depicted in FIG. 5C, the MME 220 includes, for example, the signal interface 501, the IKE terminator 502, the IPsec terminator 503, the urgent packet key exchanger 504, the packet transceiver 505, a core controller 507, the key manager 508, the timer 509, the key encrypter 510, the neighboring-apparatus controller, and the apparatus controller 512.

The signal interface 501 of the MME 220, for example, communicates with the secure GW 232 and with the core network 260. The packet transceiver 505 of the MME 220, for example, under the control of the neighboring-apparatus controller, transmits urgent packets via the IPsec terminator 503 and the signal interface 501.

The key encrypter 510 of the MME 220 encrypts the keys in urgent packets transmitted by the packet transceiver 505. The core controller 507 controls communication with the core network 260; the communication with the core network 260 uses the signal interface 501 and the IPsec terminator 503. The core controller 507 can be implemented by, for example, the core network controller 411 depicted in FIG. 4C.

The signal interface 501 can be implemented by, for example, the receiver interface 407, the transmitter interface 408, and the physical interface 409 depicted in FIG. 4C. The IKE terminator 502 can be implemented by, for example, the NWP 405 depicted in FIG. 4C. The IPsec terminator 503 can be implemented by, for example, the NWP 405 depicted in FIG. 4C.

The urgent packet key exchanger 504 can be implemented by, for example, the NWP 405 depicted in FIG. 4C. The packet transceiver 505 can be implemented by, for example, the NWP 405 depicted in FIG. 4C. The key manager 508 can be implemented by, for example, the NWP 405 and the flash memory 412 depicted in FIG. 4C.

The timer 509 can be implemented by, for example, the real-time clock 414 depicted in FIG. 4C. The key encrypter 510 can be implemented by, for example, the NWP 405 depicted in FIG. 4C. The neighboring-apparatus controller can be implemented by, for example, the radio controller 410 depicted in FIG. 4C. The apparatus controller 512 can be implemented by, for example, the CPU 401 depicted in FIG. 4C.

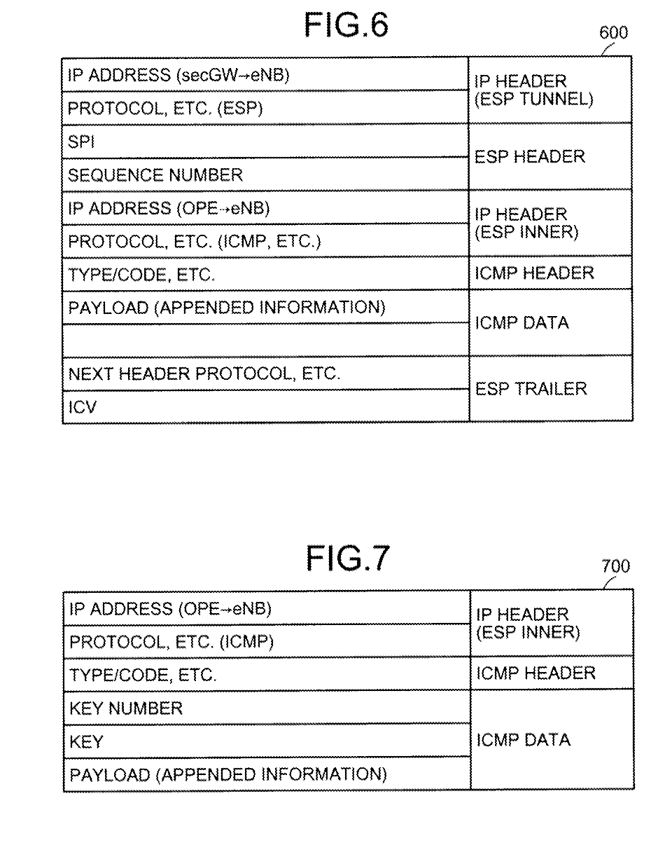

FIG. 6 is a diagram of one example of the urgent packet when a secure path is established. An urgent packet 600 depicted in FIG. 6 is an example of an urgent packet that is transmitted from the OPE 210 to the eNB 241, when a secure path is established between the secure GW 231 and the eNB 241. The “type” included in an “ICMP header” of the urgent packet 600 indicates the type of the urgent packet 600. For example, a “type” of “1” indicates that the urgent packet 600 is an urgent packet that does not include a key.

A “type” of “m” indicates that the urgent packet 600 is an urgent packet that includes a key. A “type” of “n” indicates that the urgent packet 600 is an urgent packet that includes an encrypted key. Since the urgent packet 600 does not include a key if transmitted when a secure path is established, the urgent packet 600 has a “type” of “1”.

“Code” included in the “ICMP header” is a command indicating the type of operation instructed to the destination (for example, the eNB 241) of the urgent packet 600. For example, if the “code” is “s”, an instruction for the destination of the urgent packet 600 to perform restarting is indicated. If the “code” is “t”, an instruction for the destination of the urgent packet 600 to perform downloading and transferring from a higher apparatus is indicated. If the “code” is “u”, an instruction for the destination of the urgent packet 600 to perform downloading and writing from a higher apparatus is indicated.

If the “code” is “v”, an instruction for the destination of the urgent packet 600 to perform uploading and transfer to a higher apparatus is indicated. If the “code” is “w”, an instruction for the destination of the urgent packet 600 to perform uploading and writing to an higher apparatus is indicated. If the “code” is “x”, an instruction for the destination of the urgent packet 600 to given notification of status to a higher apparatus is indicated. “Payload” included in “ICMP data” is, for example, data that includes data downloaded when the “code” is “t” or “u”.

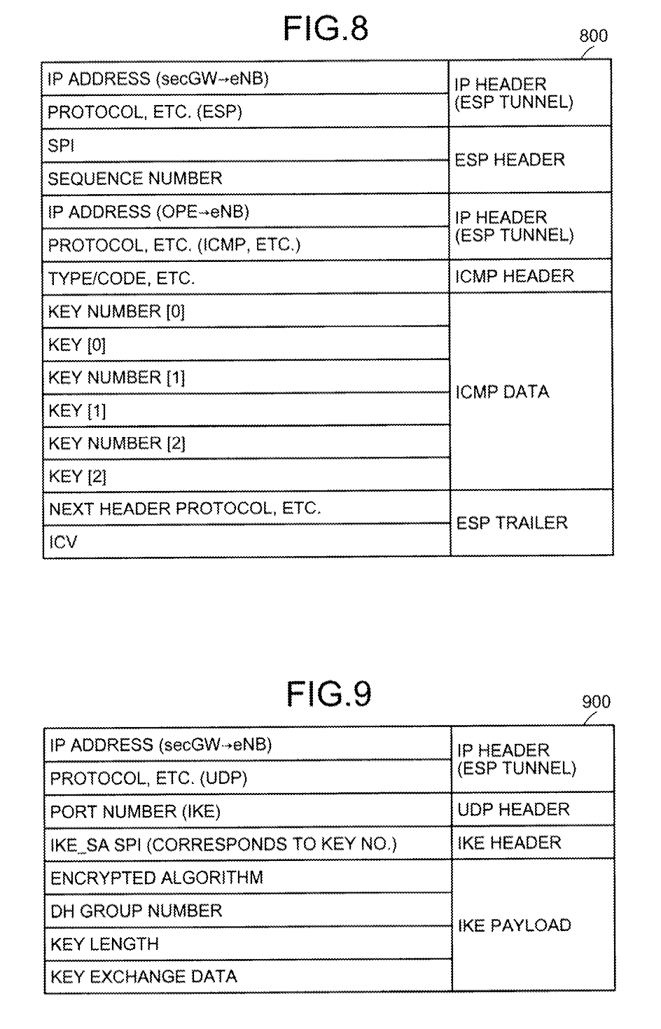

FIG. 7 is a diagram of one example of an urgent packet when a secure path is not established. In FIG. 7, components identical to those depicted in FIG. 6 are given the same reference numerals used in FIG. 6 and description thereof is omitted. An urgent packet 700 depicted in FIG. 7 is an example of an urgent packet that is transmitted from the OPE 210 to the eNB 241, when a secure path has not been established between the secure GW 231 and the eNB 241. Since the urgent packet 700 includes a key if transmitted when no secure path is established, the urgent packet 700 has a “type” of “m” or “n”.

“Key” is any key among keys that have already been exchanged between the OPE 210 and the eNB 241, by urgent key exchange packets. The “key” may be encrypted. “Key number” is information that indicates which key, the key indicated by the “key” is, among the keys that have already been exchanged between the OPE 210 and the eNB 241, by urgent key exchange packets.

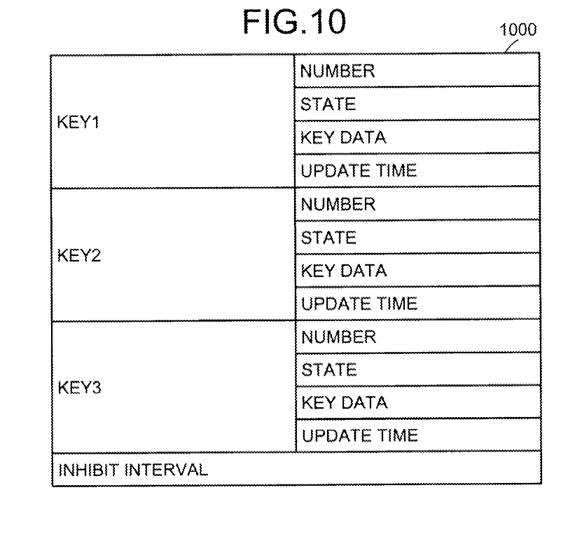

FIG. 8 is a diagram of one example of the urgent key exchange packet. An urgent key exchange packet 800 depicted in FIG. 8, for example, is an example of the urgent key exchange packet transmitted from the OPE 210 to the eNB 241. However, urgent key exchange packets transmitted from the eNB 241 to the OPE 210 and urgent key exchange packets communicated between the OPE 210 and the MME 220, etc. are similar to the urgent key exchange packet 800.

“Type” included in the “ICMP header” indicates the type of packet. For example, a “type” of “m” indicates that the urgent key exchange packet 800 is an urgent key exchange packet instructing the addition of a key indicated in “ICMP data”. A “type” of “n” indicates that the urgent key exchange packet 800 is an urgent key exchange packet instructing deletion of a key indicated in the “ICMP data”.

The “ICMP data” includes the “key” and the “key number”. Further, like the urgent key exchange packet 800, the “ICMP data” may include the “key” and “key number” in plural. In this case, each “key number” among the entries of “key” and “key number”, indicates a different number.

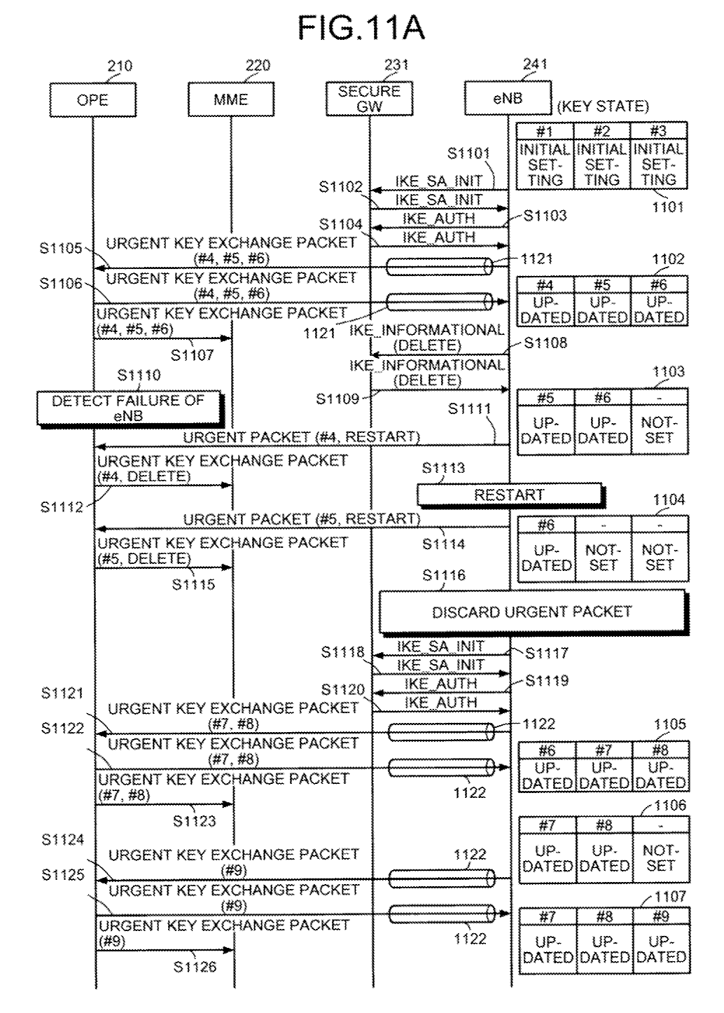

FIG. 9 is a diagram of another example of the urgent key exchange packet. An urgent key exchange packet 900 depicted in FIG. 9 is an example of an urgent key exchange packet that is transmitted from the OPE 210 to the eNB 241. However, urgent key exchange packets transmitted from the eNB 241 to the OPE 210 and urgent key exchange packets communicated between the OPE 210 and the MME 220, etc. are similar.

The urgent key exchange packet 900 is an urgent key exchange packet that uses IKE_SA_INIT. For example, a key number can be stored in “IKE_SA_SPI”, which is included in an “IKE header”. Further, a key can be stored in “key exchange data”, which is included in “IKE payload”.

FIG. 10 is a diagram of one example of the key management information. Key management information 1000 depicted in FIG. 10 is an example of key management information managed by the key manager 508 of the OPE 210, the MME 220, and the eNB 241. The key management information 1000 includes “key 1” to “key 3” and “inhibit interval”. The “key 1” to the “key 3” are, for example, keys shared by the OPE 210 and the eNB 241.

The “key 1” to the “key 3” respectively include “number”, “state”, “key data”, and “update time”. The “number” is information the respectively identifies the “key 1” to the “key 3”. The “state” indicates the state set for the key. The “state” is a value that corresponds to, for example, “initial setting” which indicates that the key is the initial value, “updated” which indicates that the key has been updated by an urgent key exchange packet, or “not set” which indicates that the key has not been set (empty).

The “key data” is data for comparing keys. The “key data” includes, for example, information such as data that is subject to comparison, key length, and an algorithm for comparison (for example, a hash value calculation method). The “update time” is information that indicates the time at which the key was updated by an urgent key exchange packet. Further, the “key 1” to the “key 3” includes an effective interval. The effective interval of “key 1” to the “key 3” is, for example, an interval from the time indicated by the “update time” until a given period of time elapses.

The “inhibit interval” is an interval from the execution of an operation (for example, restarting) by the eNB 241 and based on an urgent packet, until a given period of time elapses. Even if the eNB 241 receives an urgent packet during the interval indicated by the “inhibit interval”, the eNB 241 does not execute the operation based on the received urgent packet. As a result, for example, the eNB 241 restarts based on an urgent packet and even if an urgent packet is again received before IPsec is established, another restarting of the eNB 241 can be prevented, thereby enabling a restart attack to be avoided, for example.

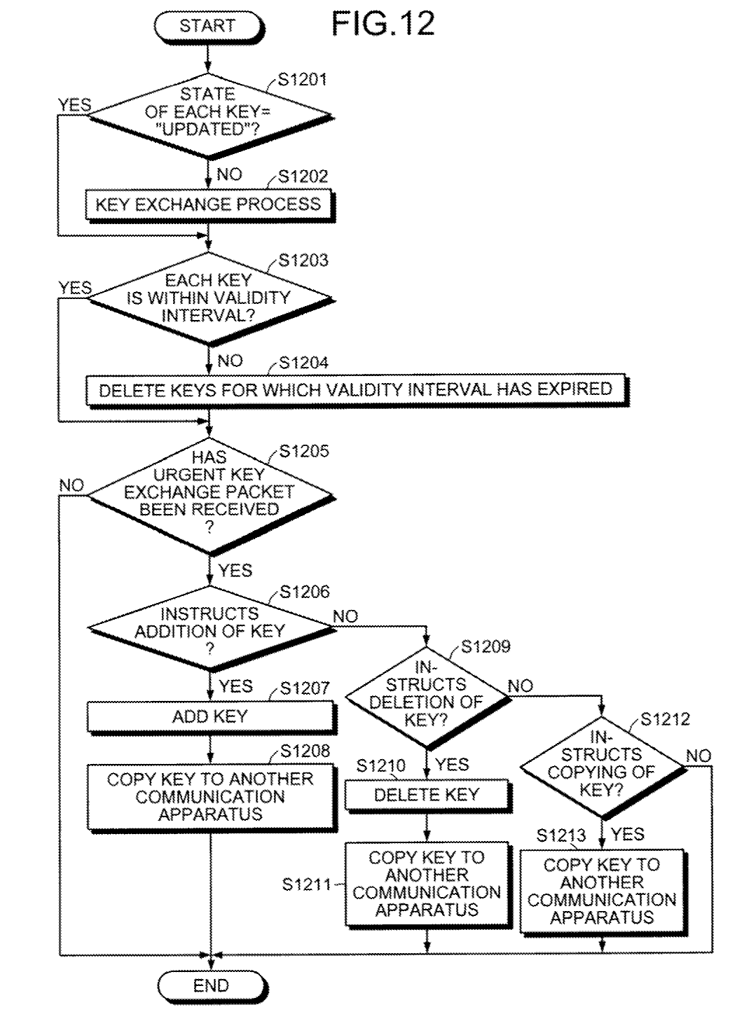

FIGS. 11A and 11B are sequence diagrams of a second operation example of the communication system depicted in FIG. 2. Key states 1101 to 1112 indicate the states of keys set by the key manager 508 of the OPE 210, the MME 220, and the eNB 241. In the key manager 508 (for example, the flash memory 412 depicted in FIG. 4) of the OPE 210, the MME 220, and the eNB 241, respective keys thereof are preliminarily stored. As indicated by the key state 1101, the keys #1, #2, #3 in the OPE 210, the MME 220, and the eNB 241 are assumed to be set at the initial settings.

For example, when power is supplied to the eNB 241 (startup), the eNB 241 transmits to the secure GW 231, a request signal (IKE_SA_INIT) for establishing a secure path (step S1101). Next, the secure GW 231 transmits to the eNB 241, an acknowledgment signal (IKE_SA_INIT) in response to the request signal transmitted at step S1101 (step S1102).

The eNB 241 transmits a request signal (IKE_AUTH) to the secure GW 231 (step S1103). The secure GW 231 transmits to the eNB 241, an acknowledgment signal (IKE_AUTH) in response to the request signal transmitted at step S1103 (step S1104). Consequent to steps S1101 to S1104, a secure path 1121 is established between the eNB 241 and the secure GW 231.

Next, since the key state 1101 indicates that the state of each of the keys is “initial setting”, the eNB 241 sets new keys #4, #5, #6 in the key manager 508 of the eNB 241. Subsequently, the eNB 241 uses the secure path 1121 established by steps S1101 to S1104 and transmits to the OPE 210, an urgent key exchange packet instructing addition of the keys #4, #5, #6 (step S1105).

The OPE 210 sets in the key manager 508 thereof, the keys #4, #5, #6, according to the urgent key exchange packet transmitted at the step S1105. Subsequently, the OPE 210 uses the secure path 1121 and transmits to the eNB 241 an urgent key exchange packet indicating that the keys #4, #5, #6 have been set (step S1106).

Further, the OPE 210 transmits to the MME 220, an urgent key exchange packet instructing the addition of the keys #4, #5, #6 (step S1107). Consequently, the MME 220 sets in the key manager 508 thereof, the keys #4, #5, #6, according to the urgent key exchange packet transmitted at step S1107. As a result, the keys #4, #5, #6 can be copied to the MME 220.

As indicated by the key state 1102, consequent to steps S1105 to S1107, the keys set in the OPE 210, the MME 220, and the eNB 241 are updated to the keys #4, #5, #6. Further, the state of each of the keys #4, #5, #6 becomes “updated”.

Here, it is assumed that an abnormality occurs on the secure path 1121. Upon detecting the abnormality on the secure path 1121, the eNB 241 transmits an IKE packet to the secure GW 231 (step S1108). Subsequently, the secure GW 231 transmits an IKE packet to the eNB 241 (step S1109). The IKE packets transmitted at steps S1108, S1109 are, for example, IKE_INFORMATIONAL(DELETE). As a result, the secure path 1121 is dropped.

Here, it is assumed that failure occurs at the eNB 241 during a state when the secure path 1121 has been dropped. In this case, the OPE 210 detects the failure of the eNB 241 (step S1110). Detection of the eNB 241 can be performed based on, for example, confirmation of communication with the eNB 241 or a notification signal from the eNB 241.

Next, the OPE 210 transmits to the eNB 241, an urgent packet that includes a command instructing restarting (step S1111). Since the secure path 1121 has been dropped, at step S1111, the OPE 210 appends to the urgent packet, the key #4, which has the smallest key number among the keys #4, #5, #6 set in the key manager 508 of the OPE 210. Further, configuration may be such that the OPE 210 encrypts the key #4 by a given scheme, and appends the encrypted key #4 to the urgent packet.

The OPE 210 further deletes from the key manager 508 thereof, the setting of the key #4, which was appended to the urgent packet. The OPE 210 transmits to the MME 220, an urgent key exchange packet instructing deletion of the key #4 (step S1112). Consequently, the MME 220 deletes the key #4 set in the key manager 508 of the MME 220.

Next, since the key #4 included in the urgent packet transmitted at step S1111 coincides with the key #4 set in the key manager 508 of the eNB 241, the eNB 241 performs restarting, according to the urgent packet (step S1113). Further, since the eNB 241 received an urgent packet that included the key #4, the eNB 241 deletes the key #4 set in the key manager 508. Consequently, as indicated by the key state 1103, the keys set in the OPE 210, the MME 220, and the eNB 241 are the keys #5, #6.

Further, configuration may be such that at step S1113, the eNB 241 determines whether the lifetime of the key #4 is valid, and if the lifetime is valid, the eNB 241 performs restarting. Moreover, configuration may be such that at step S1113, the eNB 241 determines whether inhibit interval has elapsed, and if the inhibit interval has elapsed, the eNB 241 performs restarting. After step S1113, the eNB 241 may set an inhibit interval to inhibit successive urgent packets.

Here, it is assumed that during the inhibit interval set by the eNB 241, the OPE 210 transmits to the eNB 241, an urgent packet that includes a command instructing restarting (step S1114). Since the secure path 1121 has been dropped, at step S1114, the OPE 210 appends to the urgent packet, the key #5, which has the smallest key number among the keys #5, #6 set in the key manager 508 of the OPE 210. Further, configuration may be such that the OPE 210 encrypts the key #5 by a given scheme, and appends the encrypted key #5 to the urgent packet.

The OPE 210 further deletes from the key manager 508 thereof, the setting of the key #5, which was appended to the urgent packet. The OPE 210 transmits to the MME 220, an urgent key exchange packet instructing deletion of the key #5 (step S1115). Consequently, the MME 220 deletes the key #5 set in the key manager 508 of the MME 220.

Further, since the eNB 241 received an urgent packet that included the key #5, the eNB 241 deletes the key #5 set in the key manager 508 of the eNB 241. As a result, as indicated by the key state 1104, the key set in the OPE 210, the MME 220, and the eNB 241 becomes the key #6. Subsequently, since the urgent packet transmission at step S1114 is during the inhibit interval, the eNB 241 discards the urgent packet transmitted at step S1114 (step S1116).

Since the eNB 241 performed restarting at step S1113, the eNB 241 transmits to the secure GW 231, a request signal (IKE_SA_INIT) for establishing a secure path (step S1117). Subsequently, the secure GW 231 transmits to the eNB 241, an acknowledgment signal (IKE_SA_INIT) in response to the request signal transmitted at step S1117 (step S1118).

Next, the eNB 241 transmits a request signal (IKE_AUTH) to the secure GW 231 (step S1119). The secure GW 231 transmits to the eNB 241, an acknowledgment signal (IKE_AUTH) in response to the request signal transmitted at step S1119 (step S1120). Consequent to steps S1117 to S1120, a secure path 1122 is established between the eNB 241 and the secure GW 231.

Since 2 of the keys among the keys indicated by the key state 1104 are “not set”, the eNB 241 sets new keys #7, #8 in the key manager 508 of the eNB 241. The eNB 241 uses the secure path 1122 established by steps S1117 to S1120 and transmits to the OPE 210, an urgent key exchange packet instructing the addition of the keys #7, #8 (step S1121).

Subsequently, the OPE 210 sets the keys #7, #8 in the key manager 508 of the OPE 210, according to the urgent key exchange packet transmitted at step S1121. The OPE 210 uses the secure path 1122 and transmits to the eNB 241, an urgent key exchange packet indicating that the keys #7, #8 have been set (step S1122).

The OPE 210 further transmits to the MME 220, an urgent key exchange packet instructing the addition of the keys #7, #8 (step S1123). Consequently, the MME 220 sets the keys #7, #8 in the key manager 508 of the MME 220, according to the urgent key exchange packet transmitted at step S1123. As a result, the keys #7, #8 can be copied to the MME 220. As indicated by the key state 1105, consequent to steps S1121 to S1123, the keys set in the OPE 210, the MME 220, and the eNB 241 are updated to the keys #6, #7, #8. Further, the state of the keys #6, #7, #8 becomes “updated”.

The OPE 210, the MME 220, and the eNB 241 monitor the time that elapses after the keys are updated, delete keys for which a given validity interval has expired, and set new keys. For example, assuming that validity interval for the key indicated by the key state 1105 has expired, in this case, as indicated by the key state 1106, the OPE 210, the MME 220, and the eNB 241 delete the setting of the key #6.

The eNB 241 sets a new key #9 in the key manager 508 of the eNB 241. Next, the eNB 241 uses the secure path 1122 and transmits to the OPE 210, an urgent key exchange packet instructing the addition of the key #9 (step S1124).

The OPE 210 sets the key #9 in the key manager 508 of the OPE 210, according to the urgent key exchange packet transmitted at step S1124. Next, the OPE 210 uses the secure path 1122 and transmits to the eNB 241, an urgent key exchange packet indicating that the key #9 has been set (step S1125).

The OPE 210 further transmits to the MME 220, an urgent key exchange packet instructing the addition of the key #9 (step S1126). Consequently, the MME 220 sets the key #9 in the key manager 508 of the MME 220, according to the urgent key exchange packet transmitted at step S1126. As a result, the key #9 can be copied to the MME 220.

As depicted by the key state 1107, consequent to steps S1124 to S1126, the keys set in the OPE 210, the MME 220, and the eNB 241 are updated to the keys #7, #8, #9. Further, the state of the keys #7, #8, #9 becomes “updated”.

Here, it is assumed that after the operations depicted in FIG. 11A, an abnormality occurs on the secure path 1122. Upon detecting the abnormality on the secure path 1122, the eNB 241 transmits an IKE packet to the secure GW 231 (step S1127).

The secure GW 231 transmits an IKE packet to the eNB 241 (step S1128). The IKE packets transmitted at steps S1127, S1128 are, for example, IKE INFORMATIONAL(DELETE). Consequently, the secure path 1122 is dropped.

Here, it is assumed that failure occurs at the eNB 241 during a state when the secure path 1122 has been dropped. In this case, the OPE 210 detects the failure of the eNB 241 (step S1129). Detection of the failure of the eNB 241 can be performed based on, for example, confirmation of communication with the eNB 241 or a notification signal from the eNB 241. Here, restoration of the eNB 241 by causing the eNB 241 to download a program or system settings is assumed.

Next, the OPE 210 transmits to the eNB 241, an urgent packet that includes downloaded data and a command instructing downloading and transfer (step S1130). Since the secure path 1122 has been dropped, at step S1130, the OPE 210 appends to the urgent packet, the key #7, which has the smallest key number among the keys #7, #8, #9 set in the key manager 508 of the OPE 210. Further, configuration may be such that the OPE 210 encrypts the key #7 by a given scheme, and appends the encrypted key #7 to the urgent packet.

The OPE 210 further deletes from the key manager 508 thereof, the setting of the key #7, which was appended to the urgent packet. The OPE 210 transmits to the MME 220, an urgent key exchange packet instructing deletion of the key #7 (step S1131). Consequently, the MME 220 deletes the key #7 set in the key manager 508 of the MME 220.

Next, since the key #7 included in the urgent packet transmitted at step S1130 coincides with the key #7 set in the key manager 508 of the eNB 241, the eNB 241 performs downloading and transferring, according to the urgent packet (step S1132). For example, the eNB 241 stores to nonvolatile memory such as the memory 403, downloaded data included in the received urgent packet. Further, since the MME 220 received an urgent key exchange packet instructing the deletion of the key #7, the MME 220 deletes the key #7 set in the key manager 508 of the MME 220. As a result, as indicated by the key state 1108, the keys set in the OPE 210, the MME 220, and the eNB 241 are the keys #8, #9.

The OPE 210 transmits to the eNB 241, an urgent packet that includes a command instructing downloading and writing (step S1133). Since the secure path 1122 has been dropped, at step S1133, the OPE 210 appends to the urgent packet, the key #8, which has the smallest key number among the keys #8, #9 set in the key manager 508 of the OPE 210. Further, configuration may be such that the OPE 210 encrypts the key #8 by a given scheme, and appends the encrypted key #8 to the urgent packet.

The OPE 210 deletes from the key manager 508 thereof, the setting of the key #8, which was appended to the urgent packet. The OPE 210 further transmits to the MME 220, an urgent key exchange packet instructing the deletion of the key #8 (step S1134). Consequently, the MME 220 deletes the key #8 set in the key manager 508 of the MME 220.

Since the key #8 included in the urgent packet transmitted at step S1133 coincides with the key #8 set in the key manager 508 of the eNB 241, the eNB 241 performs downloading and writing, according to the urgent packet (step S1135). For example, the eNB 241 writes to nonvolatile memory such as the flash memory 412, the downloaded data stored to the memory 403 at step S1132. Since the eNB 241 received an urgent packet that included the key #8, the eNB 241 deletes the key #8 set in the key manager 508 of the eNB 241. Consequently, as indicated by the key state 1109, the key set in the OPE 210, the MME 220, and the eNB 241 is the key #9.

The eNB 241 may perform restarting between steps S1135 and step S1136. The eNB 241 transmits to the secure GW 231, a request signal (IKE_SA_INIT) for establishing a secure path (step S1136). The secure GW 231 transmits to the eNB 241, an acknowledgment signal (IKE_SA_INIT) in response to the request signal transmitted at step S1136 (step S1137).

The eNB 241 transmits a request signal (IKE_AUTH) to the secure GW 231 (step S1138). The secure GW 231 transmits to the eNB 241, an acknowledgment signal (IKE_AUTH) in response to the request signal transmitted at step S1138 (step S1139). Consequent to steps S1136 to S1139, a secure path 1123 is established between the eNB 241 and the secure GW 231.

Since 2 of the keys among the keys indicated by the key state 1109 are “not set”, the eNB 241 sets new keys #10, #11 in the key manager 508 of the eNB 241. The eNB 241 uses the secure path 1123 and transmits to the OPE 210, an urgent key exchange packet instructing the addition of the keys #10, #11 (step S1140).

The OPE 210 sets the keys #10, #11 in the key manager 508 of the OPE 210, according to the urgent key exchange packet transmitted at step S1140. The OPE 210 uses the secure path 1123 and transmits to the eNB 241, an urgent key exchange packet indicating that the keys #10, #11 have been set (step S1141).

The OPE 210 transmits to the MME 220, an urgent key exchange packet instructing the addition of the keys #10, #11 (step S1142). Consequently, the MME 220 sets the keys #10, #11 in the key manager 508 of the MME 220, according to the urgent key exchange packet transmitted at step S1142. As result, the keys #10, #11 can be copied to the MME 220.

As indicated by the key state 1110, consequent to steps S1140 to S1142, the keys set in the OPE 210, the MME 220, and the eNB 241 are updated to the keys #9, #10, #11. Further, the state of the keys #9, #10, #11 becomes “updated”.

Here, it is assumed that an abnormality occurs on the secure path 1123. Upon detecting the abnormality on the secure path 1123, the eNB 241 transmits an IKE packet to the secure GW 231 (step S1143). The secure GW 231 transmits an IKE packet to the eNB 241 (step S1144). The IKE packets transmitted at steps S1143, S1144, for example, are IKE_INFORMATIONAL(DELETE). As a result, the secure path 1123 is dropped.

Here, restarting of the eNB 241 by the MME 220, during a state when the secure path 1123 has been dropped is assumed. Restarting of the eNB 241 by the MME 220, for example, is performed according to the restarting of the MME 220. First, the MME 220 transmits to the eNB 241, an urgent packet that includes a command instructing restarting (step S1145).

Since the secure path 1123 has been dropped, at step S1145, the MME 220 appends to an urgent packet, the key #9, which has the smallest key number among the keys #9, #10, #11 set in the key manager 508 of the MME 220. Further, configuration may be such that the MME 220 encrypts the key #9 by a given scheme, and appends the encrypted key #9 to the urgent packet.

The MME 220 further deletes from the key manager 508 thereof, the setting of the key #9, which was appended to the urgent packet. The MME 220 further transmits to the OPE 210, an urgent key exchange packet instructing the deletion of the key #9 (step S1146). Consequently, the OPE 210 deletes the key #9 set in the key manager 508 of the OPE 210.

Since the key #9 included in the urgent packet transmitted at step S1145 is coincides with the key #9 set in the key manager 508 of the eNB 241, the eNB 241 performs restarting according to the urgent packet (step S1147). Further, since the eNB 241 received an urgent packet that included the key #9, the eNB 241 deletes the key #9 set in the key manager 508 of the eNB 241. As a result, as indicated by the key state 1111, the keys set in the OPE 210, the MME 220, and the eNB 241 are the keys #10, #11.

Since the eNB 241 performed restarting at step S1147, the eNB 241 transmits to the secure GW 231, a request signal (IKE_SA_INIT) for establishing a secure path (step S1148). The secure GW 231 transmits to the eNB 241, an acknowledgment signal (IKE_SA_INIT) in response to the request signal transmitted at step S1148 (step S1149).

The eNB 241 transmits a request signal (IKE AUTH) to the secure GW 231 (step S1150). The secure GW 231 transmits to the eNB 241, an acknowledgment signal (IKE_AUTH) in response to the request signal transmitted at step S1150 (step S1151). Consequent to steps S1148 to S1151, a secure path 1124 is established between the eNB 241 and the secure GW 231.

Since 1 of the keys among the keys indicated by the key state 1111 is “not set”, the eNB 241 sets a new a key #12 in the key manager 508 of the eNB 241. The eNB 241 uses the secure path 1124 and transmits to the OPE 210, an urgent key exchange packet instructing the addition of the key #12 (step S1152).

The OPE 210 sets the key #12 in the key manager 508 of the OPE 210, according to the urgent key exchange packet transmitted at step S1152. The OPE 210 uses the secure path 1124 and transmits to the eNB 241, an urgent key exchange packet indicating that the key #12 has been set (step S1153).

The OPE 210 further transmits to the MME 220, an urgent key exchange packet instructing the addition of the key #12 (step S1154). Consequently, the MME 220 sets the key #12 in the key manager 508 of the MME 220, according to the urgent key exchange packet transmitted at step S1154. As a result, the key #12 can be copied to the MME 220.

As the key state 1112, consequent to steps S1152 to S1154, the keys set in OPE 210, the MME 220, and the eNB 241 are updated to the keys #10, #11, #12. Further, the state of the keys #10, #11, #12 becomes “updated”.

In the operations depicted in FIG. 11A and FIG. 11B, the communication of request signals, acknowledgment signals, and IKE packets, for example, is performed by the signal interface 501 and the IKE terminator 502 of the secure GW 231 and the eNB 241. Further, the communication of urgent key exchange packets, for example, is performed by the signal interface 501, the urgent packet key exchanger 504, the key manager 508, the timer 509, and the key encrypter 510 of the OPE 210, the MME 220, and the eNB 241.

The communication of urgent packets, for example, is performed by the signal interface 501, the packet transceiver 505, the key manager 508, the timer 509, and the key encrypter 510 of the OPE 210, the MME 220, and the eNB 241. Further, the restarting and downloading by the eNB 241, for example, is performed by the apparatus controller 512 of the eNB 241.

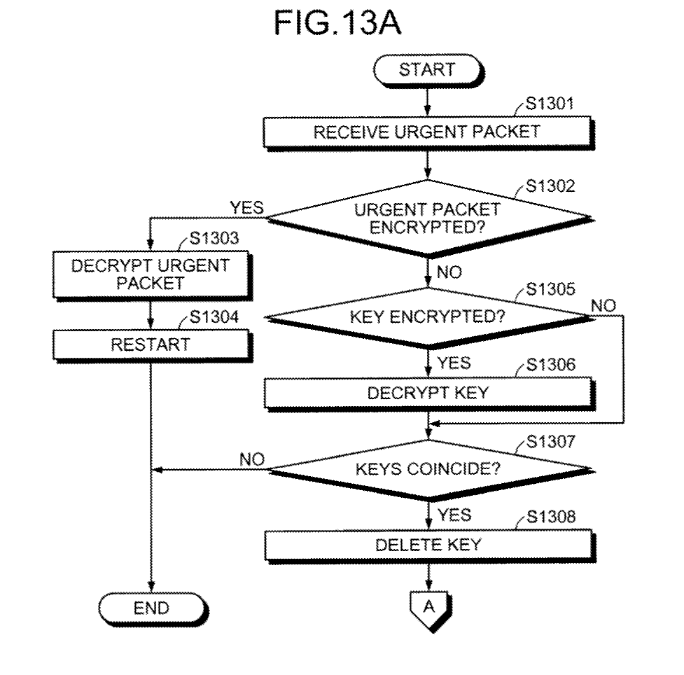

FIG. 12 is a flowchart of one example of a key management process. The key manager 508 of any one among the OPE 210, the MME 220, and the eNB 241, for example, manages keys by reiterative execution of the steps depicted in FIG. 11. Here, a management process by the OPE 210 will be described. First, the OPE 210 determines whether the state of each key set therein indicates “updated” (step S1201).

At step S1201, if the state of each key indicates “updated” (step S1201: YES), the OPE 210 proceeds to step S1203. If any the state for any one of the keys does not indicate “updated” (step S1201: NO), the OPE 210 executes a key exchange process (step S1202). For example, the OPE 210 updates each key for which the state does not indicate “updated”, by communicating urgent key exchange packets with the eNB 241 and the MME 220.

Subsequently, the OPE 210 determines whether each of the keys therein is within a validity interval (step S1203). The validity interval of a key, for example, is a period from the “update time” depicted in FIG. 10 until a given period elapses. If each of the keys is within the validity interval (step S1203: YES), the OPE 210 proceeds to step S1205. If any one of the keys is not in the validity interval (step S1203: NO), the OPE 210 deletes such keys for which the validity interval has expired (step S1204).

The OPE 210 determines whether an urgent key exchange packet has been received from another communication apparatus (for example, the eNB 241) (step S1205). If no urgent key exchange packet has been received (step S1205: NO), the OPE 210 ends process. If an urgent key exchange packet has been received (step S1205: YES), the OPE 210 determines whether the received urgent key exchange packet is an urgent key exchange packet instructing the addition of a key (step S1206).

At step S1206, if the urgent key exchange packet instructs the addition of a key (step S1206: YES), the OPE 210 sets the key in the OPE 210, according to the received urgent key exchange packet (step S1207). The OPE 210 copies the keys set therein to another communication apparatus (for example, the MME 220) (step S1208), ending the process. For example, the OPE 210 performs the copying by transmitting an urgent key exchange packet instructing the addition of the key, based on the received urgent key exchange packet.

At step S1206, if the urgent key exchange packet is not one instructing the addition of a key (step S1206: NO), the OPE 210 determines whether the received urgent key exchange packet is one that indicates the deletion of a key (step S1209). If the urgent key exchange packet is one that indicates the deletion of a key (step S1209: YES), the OPE 210 deletes the key from the OPE 210, according to the received urgent key exchange packet (step S1210).

Next, the OPE 210 copies the keys set therein to another communication apparatus (for example, the MME 220) (step S1211), ending the process. For example, the OPE 210 performs the copying by transmitting an urgent key exchange packet instructing the deletion of a key, based on the received urgent key exchange packet.

At step S1209, if the urgent key exchange packet is not one instructing the deletion of a key (step S1209: NO), the OPE 210 determines whether the received urgent key exchange packet is one that instructs the copying of a key (step S1212). If the urgent key exchange packet is one that instructs the copying of a key (step S1212: YES), the OPE 210 copies the keys set therein to another communication apparatus (for example, the MME 220) (step S1213), ending the process.

At step S1212, if the urgent key exchange packet is not one that instructs the copying of a key (step S1212: NO), the OPE 210 ends the process. Through the step above, the OPE 210 can share keys with the eNB 241. Further, the OPE 210 can copy the keys therein to the MME 220.

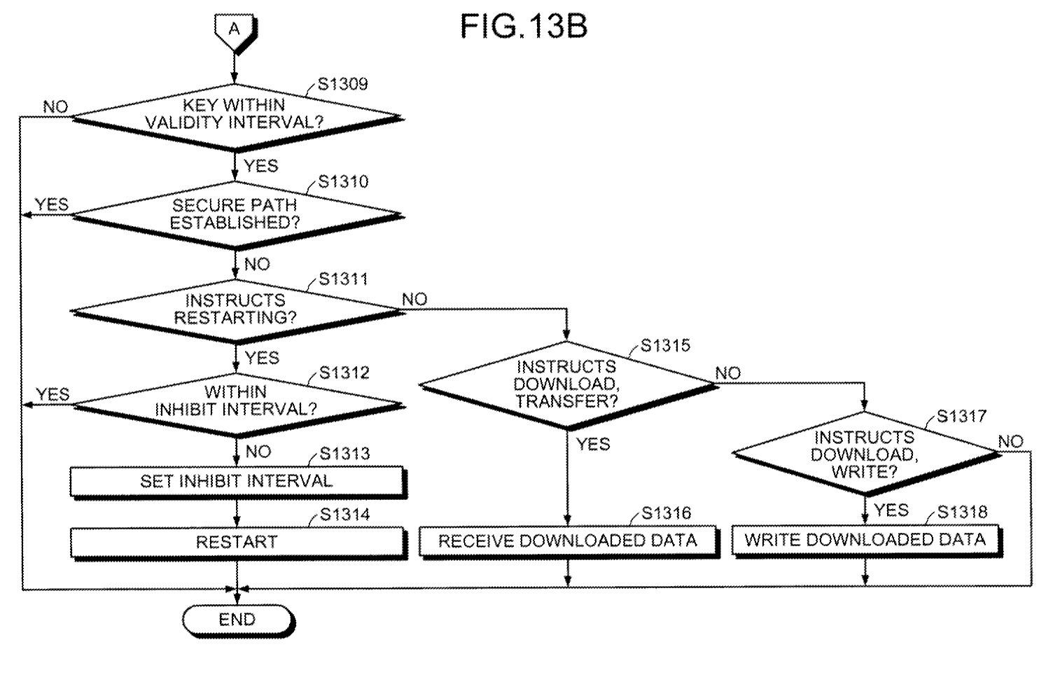

FIG. 13A and FIG. 13B are flowcharts of an example of a process when an urgent packet is received. When an urgent packet is received, the eNB 241 executes the step below, for example. First, upon receiving an urgent packet (step S1301), the eNB 241 determines whether the received urgent packet is encrypted (step S1302).

At step S1302, if the urgent packet is encrypted (step S1302: YES), the eNB 241 decrypts the received urgent packet (step S1303). Next, if the urgent packet is an urgent packet that includes a command instructing restarting, the eNB 241 performs restarting (step S1304). However, the operation instructed by the urgent packet is not limited to restarting.

At step S1302, if the urgent packet is not encrypted (step S1302: NO), the eNB 241 determines whether a key included in the received urgent packet is encrypted (step S1305). If the key is not encrypted (step S1305: NO), the eNB 241 proceeds to step S1307.

At step S1305, if the key is encrypted (step S1305: YES), the eNB 241 decrypts the key included in the urgent packet (step S1306). Next, the eNB 241 determines whether the key included in the urgent packet coincides with the key set in the eNB 241 (step S1307).

At step S1307, if the keys do not coincide (step S1307: NO), the eNB 241 ends the process. In this case, the eNB 241 may discard the received urgent packet. If the key coincide (step S1307: YES), the eNB 241 deletes from among the keys set therein, the key that was included in the received urgent packet (step S1308).

Next, the eNB 241 proceeds to the steps depicted in FIG. 13B. In other words, the eNB 241 determines whether the key deleted at step S1308 was within the validity interval (step S1309). If the key was not within the validity interval (step S1309: NO), the eNB 241 ends the process. In this case, the eNB 241 may discard the received urgent packet.

At step S1309, if the key was within the validity interval (step S1309: YES), the eNB 241 determines whether a secure path with the secure GW 231 has been established (step S1310). If a secure path has been established (step S1310: YES), the eNB 241 ends the process. In this case, the eNB 241 may discard the received urgent packet.

At step S1310, if a secure path has not been established (step S1310: NO), the eNB 241 determines whether the received urgent packet is one that includes a command instructing restarting (step S1311). If the urgent packet includes a command instructing restarting (step S1311: YES), the eNB 241 determines whether the current time is within the inhibit interval set in the key management information 1000 (refer to FIG. 10) of the eNB 241 (step S1312).

At step S1312, if the current time is within the inhibit interval (step S1312: YES), the eNB 241 ends the process. In this case, the eNB 241 may discard the received urgent packet. If the current time is not within the inhibit interval (step S1312: NO), the eNB 241 sets the inhibit interval in the key management information 1000 of the eNB 241 (step S1313). For example, the eNB 241 sets, as the inhibit interval, an interval from the current time until a given period elapses. The eNB 241 executes restarting (step S1314), ending the process.

At step S1311, if the received urgent packet does not include a command instructing restarting (step S1311: NO), the eNB 241 determines whether the received urgent packet includes a command instructing downloading and transferring (step S1315). If the received urgent packet includes a command instructing downloading and transferring (step S1315: YES), the eNB 241 receives the downloaded data included in the urgent packet (step S1316), ending process. At step S1316, the eNB 241, for example, stores the downloaded data to the memory 403.

At step S1315, if the received urgent packet does not include a command instructing downloading and transferring (step S1315: NO), the eNB 241 determines whether the received urgent packet includes a command instructing downloading and writing (step S1317). If the received urgent packet includes a command instructing downloading and writing (step S1317: YES), the eNB 241 writes to the flash memory 412, the downloaded data stored in the memory 403 (step S1318), ending the process.

At step S1317, if the received urgent packet does not include a command instructing downloading and writing (step S1317: NO), the eNB 241 ends the process. Through the steps above, the eNB 241 can confirm that the received urgent packet is from the OPE 210, based on a key and can perform an operation based on the urgent packet.

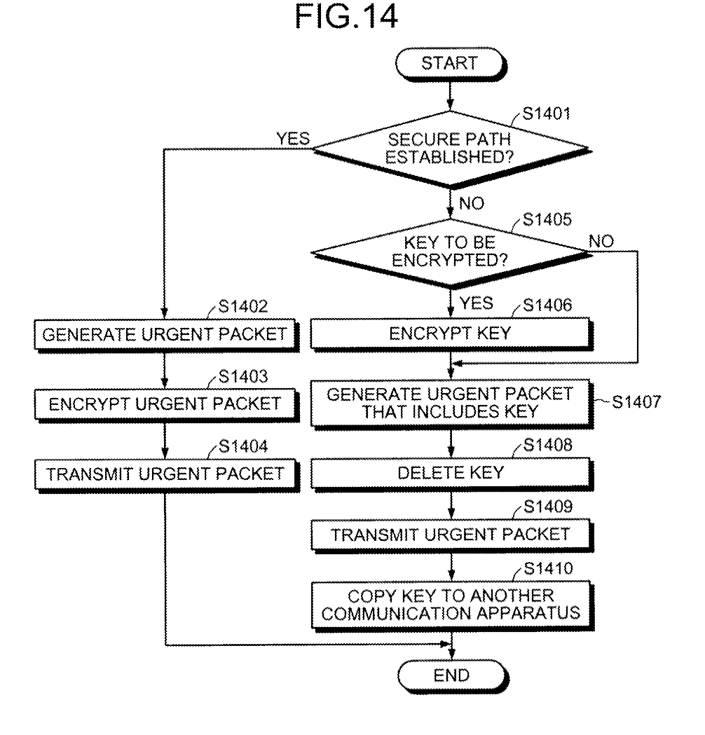

FIG. 14 is a flowchart of one example of a process when an urgent packet is transmitted. For example, when an urgent packet is transmitted to the eNB 241, the OPE 210, for example, executes the steps below. As indicated in FIG. 14, when an urgent packet is transmitted, the OPE 210 determines whether a secure path has been established between the secure GW 231 and the eNB 241 (step S1401).

At step S1401, if a secure path has been established (step S1401: YES), the OPE 210 generates an urgent packet (step S1402). Next, the OPE 210 encrypts the urgent packet generated at step S1402 (step S1403). The OPE 210 transmits the urgent packet encrypted at step S1403 to the eNB 241 (step S1404), ending the process. As a result, the OPE 210 uses the secure path and can assure security and transmit an urgent packet.

At step S1401, if a secure path is not established (step S1401: NO), the OPE 210 determines whether a key stored in the urgent packet is to be encrypted (step S1405). The determination at step S1405, for example, is performed based on preliminary settings. If the key is not to be encrypted (step S1405: NO), the OPE 210 proceeds to step S1407.

At step S1405, if the key is to be encrypted (step S1405: YES), the OPE 210 encrypts the key (step S1406). The OPE 210 generates an urgent packet that includes the key (step S1407). The OPE 210 deletes therefrom, the key that is included in the urgent packet generated at step S1407 (step S1408).

The OPE 210 transmits the urgent packet generated at step S1407 to the eNB 241 (step S1409). As result, even if a secure path has not been established, the OPE 210 can assure security and transmit an urgent packet. The OPE 210 copies the keys set therein to another communication apparatus (the MME 220) (step S1410), ending the process.

In this manner, in the communication system 100 according to the embodiment, a packet that includes an operation command and a key that is a counterpart to a key of a subordinate apparatus (the communication apparatus 120) is transmitted from the communication apparatus 110 to the subordinate apparatus. As a result, even if the secure path 101 has not been established, security can be assured and the subordinate apparatus can be remotely operated.

For example, if a failure of the eNB 241 causes a program or system setting error, restoration is possible by causing the eNB 241 to execute restarting, downloading, etc. by remote operation, without physically going to the eNB 241. Further, by causing an execution of uploading by remote operation, the status of the eNB 241 can be confirmed. Thus, improved operating rates and lower maintenance costs can be achieved.

Furthermore, commands can be transmitted as plain text, without encryption. Therefore, for example, the communication apparatus 110 need not have a function for decrypting commands when the secure path 101 is not established. Therefore, a function that assures security and transmits commands in a state when the secure path 101 is not established can be implemented by a simple configuration.

As described, according to the communication apparatus, the communication system, and the communication method, the security of remote operation can be improved even when a secure path is not established. In the embodiment above, although system restoration by remotely operating the communication apparatus 120 has been described, the communication system 100 can apply the configuration of remotely operating the communication apparatus 120, without limitation to system restoration.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus comprising:
a processor configured to determine whether a secure path has been established between the communication apparatus and a given communication apparatus, when the communication apparatus transmits to the given communication apparatus, a command causing execution of a given operation;
an acquirer that acquires a transmission-side key having a given correspondence relation with a reception-side key that is acquired by the given communication apparatus; and
a transmitter that transmits to the given communication apparatus a packet that includes the acquired transmission-side key and the command, if the processor has determined that the secure path has not been established.

2. The communication apparatus according to claim 1, wherein the secure path is a path along which the packet is transmitted encrypted.

3. The communication apparatus according to claim 1, wherein
the acquirer acquires a different transmission-side key for each transmission of the command, by the transmitter.

4. The communication apparatus according to claim 1, and further comprising
a registrar that sets the transmission-side key by communicating with the given communication apparatus, using the secure path, wherein
the acquirer acquires the transmission-side key set by the registrar.

5. The communication apparatus according to claim 4, wherein
acquirer does not acquire the transmission-side key if a given interval has elapsed since the transmission-side key was set by the registrar.

6. The communication apparatus according to claim 1, and further comprising
an encrypter that encrypts the acquired transmission-side key, wherein
the transmitter transmits the packet including the encrypted transmission-side key.

7. A communication apparatus comprising:
a receiver that receives a packet that includes a key and a command causing execution of a given operation;
an acquirer that acquires a reception-side key that has a given correspondence relation with a transmission-side key that is acquired by a given communication apparatus; and
a processor configured to determine whether the key included in the received packet and the acquired reception-side key have the given correspondence relation; and configured to execute the given operation according to the command included in the packet, if determining the key included in the received packet and the acquired reception-side key have the given correspondence relation.

8. The communication apparatus according to claim 7, wherein
the acquirer acquires a different reception-side key for each reception of the command, by the receiver.

9. The communication apparatus according to claim 7, and further comprising
a registrar that sets the reception-side key by communicating with the given communication apparatus, using a secure path established between the communication apparatus and the given communication apparatus, wherein
the acquirer acquires the reception-side key set by the registrar.

10. The communication apparatus according to claim 9, wherein
the acquirer does not acquire the reception-side key if a given interval has elapsed since the reception-side key was set by the registrar.

11. The communication apparatus according to claim 7, and further comprising
an decrypter that decrypts the key included in the packet received by the receiver, wherein
the processor determines whether the key decrypted by the decrypter and the reception-side key have the given correspondence relation.

12. The communication apparatus according to claim 7, wherein
the given operation includes restarting of the communication apparatus, and
the processor does not perform the restarting according to the command, during an interval beginning after the processor restarts the communication apparatus and lasting until a given period elapses.

13. A communication system comprising:
a first communication apparatus that when a secure path is not established between the first communication apparatus and a second communication apparatus, transmits a packet that includes a given transmission-side key and a command that causes execution a given operation; and
the second communication apparatus that receives a packet that includes a key and a command that causes execution of a given operation, and when the key included in the received packet and a reception-side key having a given correspondence relation with the transmission-side key have the given correspondence relation, executes the given operation according to the command included in the received packet.

14. A communication method comprising:
transmitting by a first communication apparatus and when a secure path is not established between the first communication apparatus and a second communication apparatus, a packet that includes a given transmission-side key and a command that causes execution of a given operation;
receiving by the second communication apparatus, a packet that includes a key and a command that causes execution of a given operation; and
executing the given operation by the second communication apparatus and according to the command included in the received packet, when the key included in the received packet and a reception-side key having a given correspondence relation with the transmission-side key have the given correspondence relation.
